(19) United States
(12) Patent Application Publication
(10) Pub. No.: US 2021/0056806 A1
(43) Pub. Date: Feb. 25, 2021

(54) GAMING SYSTEM AND METHOD INCLUDING SIDE BETS

(71) Applicant: ADP GAUSELMANN GMBH, Espelkamp (DE)

(72) Inventor: Michael Charles Halvorson, Las Vegas, NV (US)

(21) Appl. No.: 16/549,830

(22) Filed: Aug. 23, 2019

(51) Int. Cl. G07F 17/32

(52) U.S. Cl. CPC G07F 17/3258; G07F 17/3262

(57) ABSTRACT

A gaming system and method include side bet wagering on various game elements, game features, or some combination thereof. Selectable side bet symbols that the player can select for a side bet are displayed, and the player may win the side bet if the gaming system generates the selected side bet symbol in a winning symbol combination or based on some other suitable evaluation criteria. The selectable side bet symbols may be symbols that are used in a game (e.g., a slot reel game or other suitable games). The gaming system may change the available selectable side bet symbols in different plays of a game. The gaming system may present the side bet symbols in a pop out or slide out window (e.g., a slide out information area) of a game screen. The player may place a side bet on a non-traditional pay line or a player-drawn pay line.

### FIELD OF THE DISCLOSURE

The present disclosure relates to gaming devices.

### BACKGROUND

Gaming machines accept wagers from players in exchange for the opportunity to win awards or prizes. Current gaming machines use computing devices that control various technologies to provide specialized systems adapted to gain the attention of players and to keep them engaged with the gaming machines. To retain players' interest, gaming machines that offer new and unconventional functionality are needed.

### SUMMARY

Various implementations of a gaming system and method include side bet wagering on various game elements, game features, or some combination thereof.

In some implementations, the gaming system displays one or more selectable side bet symbols that the player can select for a side bet. In some implementations, for example, if the gaming system displays an Ace symbol as a selectable side bet symbol and the player selects the Ace symbol for a side bet, the player wins the side bet if the gaming system generates an Ace in a winning symbol combination. In some implementations, the selectable side bet symbols are symbols that are used in a game (e.g., a slot reel game or other suitable games that generate symbols). In some implementations, selectable side bet symbols may be displayed with a required wager and an associated side bet award for winning the side bet. In some implementations, a player selected symbol for a side bet is a win when the player selected symbol appears as part of a winning scatter symbol combination. It should be appreciated that in various implementations, a selectable side bet symbol can result in a side bet award if a player selected the selectable side bet symbol and the gaming system generated such side bet symbol during a play of a game when the side bet was active.

In some implementations, the gaming system provides multiple options for side bets. For example, the gaming system may display one or more selectable side bet symbols to the player for the player's selection in some implementations. In some implementations, the gaming system displays three selectable side bet symbols to the player for selection. It should be appreciated that the gaming system can display any suitable number of selectable side bet symbols as selection options.

In some implementations, the gaming system may display the selectable side bet symbols below a main game screen area (e.g., below slot reels). In alternative implementations, the gaming system may display the selectable side bet symbols in any suitable area of a game screen. In some implementations, the gaming system may display the selectable side bet symbols in display devices different from a display device displaying a main game screen. In some implementations, the gaming system may display the selectable side bet symbols in a programmable button deck of the gaming system.

In some implementations, a gaming system may keep a particular player selected side bet active until player makes a different side bet selection or stops/deactivates the particular player selected side bet. For example, in some implementations, the gaming system may display multiple selectable side bet symbols. In some implementations, when a player selects one or more of the multiple selectable side bet symbols, the gaming system automatically collects a side bet wager on the selected side bet symbol for more than one play of a game (e.g., keeping the side bet wager active for multiple plays of the game). In some implementations, the gaming system may keep the side bet wager active until the player runs out of credits to wager. In some implementations, the gaming system may keep the side bet wager active for a predetermined quantity of plays of a game (e.g., three games or some other suitable number of games).

In some implementations with side bets, the gaming system may change the available selectable side bet symbols in different plays of a game. In some implementations, the gaming system changes one or more available selectable side bet symbols every new play of the game. For example, in some implementations, the one or more available selectable side bet symbols can be randomly changed (so that different symbols can be offered for a side bet). In some implementations, the gaming system changes one or more available selectable side bet symbols after a predetermined quantity of plays of a game. In some implementations, the gaming system changes one or more available selectable side bet symbols after a randomly generated number of plays of a game.

In some implementations, the gaming system may enable a player to select from any number of symbols to be selectable side bet symbols. In some implementations, the gaming system provides a selectable side bet symbol set including a plurality of side bet symbols that the player can review and select for one or more side bets. In some implementations, the selectable side bet symbol set may include all of the symbols that the gaming system uses for an associated game. In some implementations, the selectable side bet symbol set may include fewer than all of the symbols that the gaming system uses for an associated game. In some implementations, the gaming system may present a predetermined quantity of the side bet symbols in the selectable side bet symbol set in a pop out or slide out window (e.g., a slide out information area) of a game screen. The gaming system may enable the player to scroll through available selectable side bet symbols within the slide out information area. In some implementations, a slide out information area also provides the player with symbol pay table information. In some implementations, the slide out information area provides the player with other suitable game information such as side bet wager information, side bet award information, jackpot information, player tracking information, awards, offers, etc.

In some implementations, the gaming system enables the player to place side bet wagers on one or more particular pay lines. In some implementations, the gaming system may enable the player to select any available pay line for a side wager. In other implementations, the gaming system provides a predetermined quantity of pay lines (e.g., fewer than the total amount of available pay lines) that are available for a side bet. For example, in some implementations, the gaming system may enable a player to place a side bet wager on pay line number 5 of 50 pay lines in a game. In such an example, if the gaming system generated a winning symbol combination on pay line number 5, the player may win the award associated with the winning symbol combination on pay line number 5 (e.g., the standard game award associated with a pay table) as well as winning the side bet wager on pay line number 5.

In some implementations, the gaming system may enable the player to place a side bet on a non-traditional pay line. For example, if a slot reel game includes pay lines that evaluate and pay from the left reel to the right reel, the gaming system may offer the player side bets on one or more pay lines that pay from right to left or that are evaluated from the center of reels. In some implementations, these non-traditional pay lines that are available for a side bet wager are predetermined and the player can select from an available list of non-traditional pay lines. In some implementations, the gaming system enables the player to pick the player's own non-traditional pay line. For example, in some implementations, the gaming system enables a player to draw a pay line. In some implementations, the gaming system may enable the player to pick the start and the end of a pay line anywhere in a game. In some implementations, the pay line may start evaluating winning symbol combinations in the center of reels or symbol display areas. In some implementations, custom player drawn pay lines may have minimum number of symbols display areas and reels that must be included in the player's unique pay line. In some implementations, if a winning combination of symbols is generated on the player's unique pay line, the player wins the side bet. The gaming system may vary side bet awards based on the quantities of symbols in pay line or the design of the pay line.

In some implementations, the gaming system may enable a player to select different custom winning symbol combinations for a side bet wager. In some implementations, the gaming system must dynamically determine, at the time of player selection of symbols that form a winning symbol combination, that the side bet award can be based on the statistical likelihood of the gaming system generating the symbols and the return to player value required at the gaming system.

In some implementations, the gaming system enables a player to select one or more symbol display areas and place a side bet wager that the gaming system will generate a particular symbol in the selected one or more symbol display areas during the next play of the game.

It should be appreciated that in various side bet implementations discussed herein, the gaming system may provide a game with or without a standard wagering option that can be used with one or more of the various side bet implementations. For example, in some implementations, the gaming system provides the player with a slot reel game that accepts wagers on pay lines or based on ways pays. In some implementations, the slot reel game enables the player to place one or more side bets along with the standard wagering options for the slot reel game. Thus, a gaming system with side bets provides many additional opportunities for the player to place wagers and win additional awards.

As described above and set forth in greater detail below, gaming systems in accordance with aspects of the present disclosure provide a specialized computing device including non-conventional hardware and software that improve upon the existing technology of human-computer interfaces by providing functionality of generating display outputs that enable players to collect symbols and generate new awards. Doing so improves the operation of the gaming systems for their specialized purpose by reducing player disappointment with game outcomes and enhancing player excitement for a game.

### BRIEF DESCRIPTION OF THE DRAWINGS

FIG. 1 shows a perspective view illustrating an example gaming device in accordance with aspects of the present disclosure.

FIG. 2 shows a functional block diagram illustrating a gaming system in accordance with aspects of the present disclosure.

FIG. 3A shows a process flow diagram illustrating an example method of operating the gaming system having side bets in accordance with aspects of the present disclosure.

FIG. 3B shows a process flow diagram illustrating an example method of operating the gaming system having side bets in accordance with aspects of the present disclosure.

FIG. 4A shows a picture of a gaming system display illustrating an example side bet implementation in accordance with aspects of the present disclosure.

FIG. 4B shows a picture of a gaming system display illustrating an example side bet implementation in accordance with aspects of the present disclosure.

FIG. 4C shows a picture of a gaming system display illustrating an example side bet implementation in accordance with aspects of the present disclosure.

FIG. 5A shows a picture of a gaming system display illustrating an example side bet implementation in accordance with aspects of the present disclosure.

FIG. 5B shows a picture of a gaming system display illustrating an example side bet implementation in accordance with aspects of the present disclosure.

FIG. 6 shows a picture of a gaming system display illustrating an example side bet implementation in accordance with aspects of the present disclosure.

### DETAILED DESCRIPTION

Various implementations of a gaming system and method include side bet wagering on various game elements, game features, or some combination thereof. In some implementations, the gaming system displays one or more selectable side bet symbols that the player can select for a side bet. For example, the selectable side bet symbols may be symbols that are used in a game (e.g., a slot reel game or other suitable games that generate symbols), and/or selectable side bet symbols that may be displayed with a required wager and an associated side bet award for winning the side bet. A player-selected symbol for a side bet wager may be a win, for example, when the player selected symbol is generated as part of a winning symbol combination (e.g., in a pay line) and/or appears as part of a winning scatter symbol combination. In some implementations, the gaming system provides multiple options for side bets, such as displaying one or more selectable side bet symbols to the player for the player's selection.

In some implementations, a gaming system includes a cabinet, a processor, a display device supported by the cabinet, an input device supported by the cabinet, a value acceptor supported by the cabinet, a value dispenser supported by the cabinet, and a memory device that stores program instructions. The program instructions, when executed by the processor, control the gaming device to perform operations including establishing a credit balance based at least in part on a monetary value received by the value acceptor. The operations can also include placing a wager following receipt of a wager input via the input device, the credit balance being decreased by the wager. The operations can also include receiving a selection of one of a plurality of side bet symbols and automatically deducting a side bet wager amount based on the selected side bet symbol, wherein the credit balance is decreased by the side bet wager amount. The operations can include randomly generating a plurality of symbols in a plurality of symbol display areas and displaying the plurality of symbols in the plurality of symbol display areas. The operations can include determining an award based on any winning symbol combinations in the generated plurality of symbols in the plurality of symbol display areas and determining a side bet award when the selected side bet symbol is contained in the any winning symbol combinations of the generated plurality of symbols. The operations can include displaying, on the display device, the determined award and the side bet award and increasing the credit balance by the award and the side bet award, and issuing value from a value dispenser based on the credit balance upon receipt of a cash out signal via the input device.

In some implementations, the gaming system may display the selectable side bet symbols in any suitable area of a game screen, such as below a main game screen area (e.g., below slot reels). In some implementations, the gaming system may display the selectable side bet symbols in display devices different from a display device displaying a main game screen. In some implementations, the gaming system may display the selectable side bet symbols in a programmable button deck of the gaming system.

In some implementations, a gaming system may keep a particular player selected side bet active until a player makes a different side bet selection or stops/deactivates the particular player selected side bet. For example, in some implementations, the gaming system may display multiple selectable side bet symbols and when a player selects one or more of the multiple selectable side bet symbols, the gaming system automatically collects a side bet wager on the selected side bet symbol for more than one play of a game (e.g., keeping the side bet wager active for multiple plays of the game). In some implementations, the gaming system may keep the side bet wager active until the player runs out of credits to wager. In some implementations, the gaming system may keep the side bet wager active for a predetermined quantity of plays of a game (e.g., three games or some other suitable number of games).

In some implementations, the gaming system may change the available selectable side bet symbols in different plays of a game, such as randomly changing the one or more available selectable side bet symbols (so that different symbols can be offered for a side bet). In some implementations, the gaming system may change one or more available selectable side bet symbols during every one or more new plays of the game; after a predetermined quantity of plays of a game; and/or after a randomly generated number of plays of a game.

In some implementations, the gaming system may enable a player to select from any number of symbols, such as providing a selectable side bet symbol set identifying symbols from which the player can select for one or more side bets. In some implementations, the gaming system may present a predetermined quantity of the side bet symbols in the selectable side bet symbol set in a pop out or slide out window (e.g., a slide out information area) of a game screen and may enable the player to scroll through available selectable side bet symbols within the slide out information area. In some implementations, a slide out information area also provides the player with symbol pay table information and/or other suitable game information, such as side bet wager information, side bet award information, jackpot information, player tracking information, awards, offers, etc.

In some implementations, the gaming system enables the player to place side bet wagers on one or more particular pay lines. In some implementations, the gaming system may enable the player to select any available pay line for a side wager, and in other implementations, the gaming system provides a predetermined quantity of pay lines (e.g., fewer than the total amount of available pay lines) that are available for a side bet. In some implementations, the gaming system may enable the player to place a side bet on: a non-traditional pay line in a slot reel game having pay lines that generally evaluate winning symbol combinations from a far left reel to far right reel, one or more alternative pay lines that are evaluated from right to left and/or that are evaluated starting from reels other than the far left reel of a set of reels. In some implementations, these non-traditional pay lines that are available for a side bet wager are predetermined, and the player can select from an available list of non-traditional pay lines. In some implementations, gaming system enables the player to define a pay line, such as enabling a player to draw a pay line and/or to provide one or more inputs to define the pay line based on picking a start and an end of a pay line. In some implementations, player-defined pay lines may include a minimum number of symbols display areas from a minimum number of reels. In some implementations, if a winning combination of symbols is generated on the player's unique pay line, the player wins the side bet. The gaming system may vary side bet awards based on the quantities of symbols in pay line or the design of the pay line.

In some implementations, the gaming system may enable a player to select different custom winning symbol combinations for a side bet wager. In some implementations, the gaming system dynamically determines, at the time of player selection of symbols that form a winning symbol combination, what the side bet award can be based on the statistical likelihood of the gaming system generating the symbols and the return to player value required at the gaming system. In some implementations, the gaming system enables a player to select one or more symbol display areas and place a side bet wager that the gaming system will generate a particular symbol in the selected one or more symbol display areas during one or more next plays of a game.

### Gaming Device Platform

The features and advantages of the gaming system and method described herein may be provided to a player via a gaming device platform that includes various structures and components for allowing player interaction with the gaming device. While only one gaming device platform will be described in detail herein, it is understood that the features, objects, and advantages of the gaming system described herein may be implemented in one or more alternative gaming device platforms.

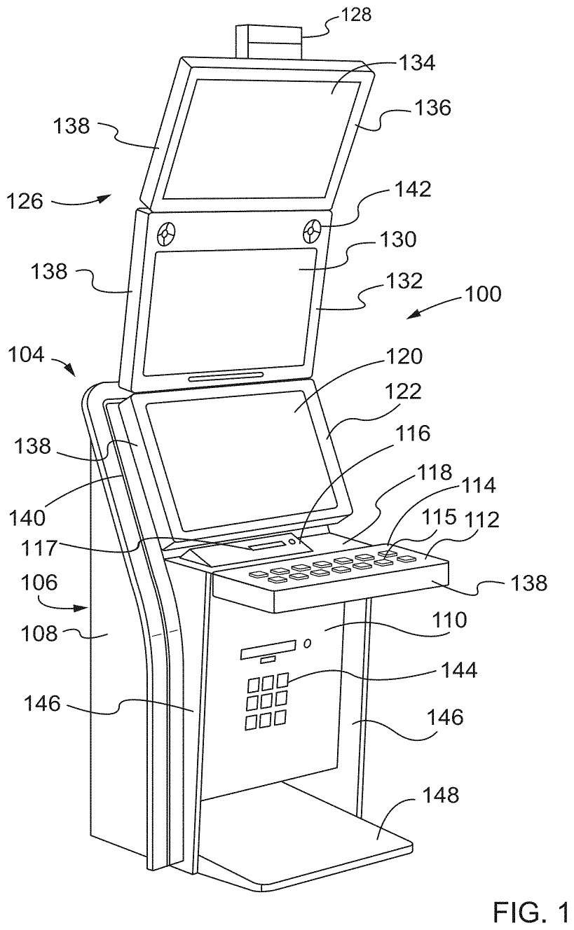

FIG. 1 shows a perspective view illustrating an example of gaming system 100 in accordance with aspects of the present disclosure. Such gaming system 100 may be referred to as a slot machine and, as illustrated, is housed in a cabinet 104 (e.g., a housing) constructed so that a player can operate and play the gaming system 100 while standing or sitting. The cabinet 104 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 104, 106, 108, 110 (as well as the base panel and the top panel surface) may be interconnected along their edges and cooperate to form the cabinet 104, which encloses and houses components of the gaming system 100, as can be seen in FIG. 1. The cabinet 104 may function to securely protect local control system, technology components, and provide support for game display(s) and player input and output interactions with the gaming system 100, such as describe herein below.

While the example cabinet 104 is depicted as having a particular shape, structure, and organization, it should be appreciated that a wide variety of cabinet enclosure sizes, shapes, and designs are possible for the gaming system 100. For example, the cabinet panels 104, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 104 includes input and output areas generally designated as the player interaction area 112. The player interaction area 112 may be located on the front top side of cabinet 104 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons and touch sensitive areas, through with which players may interact with the gaming system 100 so as to direct game play. It is expected that the cabinet 104 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device, or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/player tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enable a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 104 may be dependent upon the game buttons, the type of value wagered, and the player conveniences utilized in the deployment configuration of gaming system 100.

With continuing reference to FIG. 1, in some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display 120 may span the one or more portions of the cabinet 104 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game displays.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the main game display(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

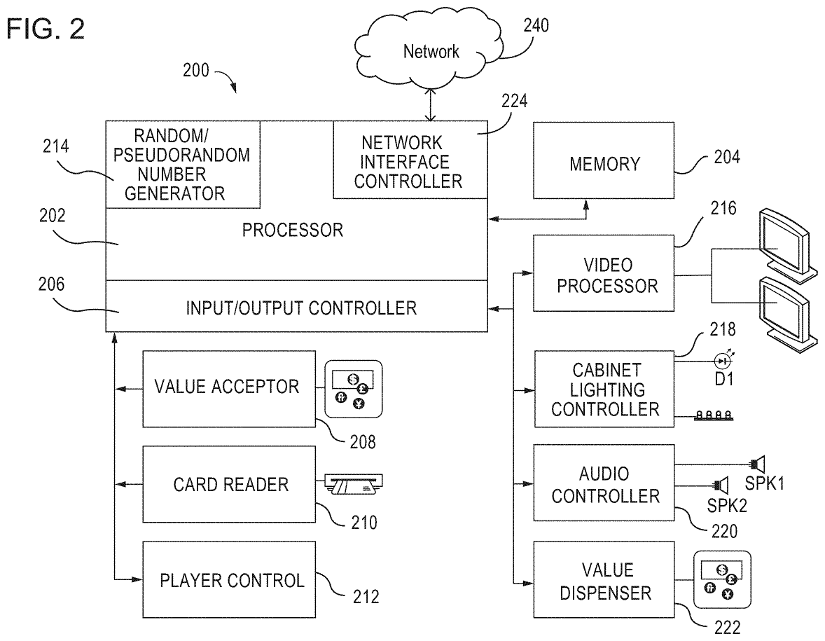

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 104 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 104 includes cabinet accent lighting 140. In some implementations, cabinet accent lighting 140 is LED rope lighting mounted flush with the front side edge of the cabinet side panels 108. The LED rope lighting can generate any of suitable colors, and are controlled by cabinet lighting controller and a processor of gaming system 100 to selectively mix the emitted light colors in a manner to create any color in the same manner as the frame edge lighting.

In various implementations, gaming system 100 includes one or more audio speakers 142 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 142 are shown mounted on the upper corners of second display frame 132. Any suitable number of additional speakers 142 may be provided on additional display frames or on the lower cabinet body portion 106 as desired.

The speakers 142 designed for emitting bass vibrations may be included in some implementations. Placement of the speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing the gaming system 100 in a seated position. Foot rest 148, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 104 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 illustrates a functional block diagram of a control unit 200 of a gaming system (e.g., gaming system 100) configured to perform specialized game functions and operations, consistent with the implementations described herein. The functional elements shown in FIG. 2 cooperate, on a broad and general level, to function as a gaming system. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In accordance with aspects of the present disclosure, the control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one implementation, the control unit 200 is also configured to communicate with a server device through a network.

In some implementations, the control unit 200 includes at least one processor 202 (e.g., a central processing unit (CPU)). In some implementations, the processor 202 is specially configured with arithmetic logic units and math co-processors, also known as floating point units, for performing the gaming consistent with the various implementations disclosed herein. In some implementations, the specially configured processor 202 includes registers for holding instructions or other data, and cache memory for storing data for faster operation thereupon. In some implementations, the specially configured processor 202 may be a multi-core processor that includes two or more processors for enhanced performance, more efficient parallel processing, or other advantageous computing functions. In another implementation, the specially configured processor 202 may be one or more processing devices such as microprocessor(s) or integrated circuit(s) and may include one or more controllers. It should be appreciated that in some implementations, a general-purpose processor could be programmed to perform the functions of the specially configured processor 202.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

At least one specially configured processor 202 or controller of control unit 200 may be specially configured to communicate with at least one memory device 204, generally shown as memory device 204 in FIG. 2. In some implementations, the memory device 204 includes one or more memory structures for storing instructions and various types of game data. The memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in some implementations, communication with the memory device 204 by the specially configured processor 202 or a controller, encompasses the processor or controller accessing the memory device 204, exchanging data with the memory device 204, or storing data to the memory device 204.

The memory device 204 may store all program code and game code (collectively the “code”), and operation data necessary for the operation of the control unit 200 providing a gaming device and execution of the gaming features described hereinbelow. In an alternative implementation, game code and operation data necessary for the operation of the control unit 200 may be stored in a distributed manner such that some code is stored in memory device 204 and other code is stored remotely from the control unit 200. In some implementations, the code and operation data necessary for the operation of the control unit 200 includes, for example, basic input and output function data, instruction fetching data, bus and network communication protocol data, and like data necessary for an operational gaming device. In some implementations, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in removable game cartridges or flash drives, a compact disk ROM, a digital versatile disk (DVD) optical storage technology, or suitable other fixed non-transitory storage mediums. In another implementation, part or all of the code and operational data for operation of the gaming device or for execution of the game features may be stored in a remote memory structure and be downloaded to the memory device 204 via a network connection.

In some implementations, the control unit 200 may utilize any combination of memory devices such as random access memory devices (RAMs), unalterable memory devices (ROMs), and mass storage devices for securely storing and securely communicating the software components or code that facilitate game play and other functions of the control unit 200. The memory devices may store software components or code that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the control unit 200.

In some implementations, memory devices, such as memory device 204, with the software components and other data may be secured and authenticated by authentication software stored in an unalterable memory device within the housing of the control unit 200. The control unit 200 may also include application specific integrated circuits (ASICs) to perform the security and authentication functions. At any appropriate time, such as before each play of a game, at a predetermined interval, upon transfer of any game data or any software components from a mass storage to the memory device 204, or upon demand, the control unit 200 (using a processor such as processor 202 or a separate ASIC) may execute an authentication routine and perform an authentication of any software component or other data of the control unit 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the control unit 200 may allow game play to proceed. However, when the message digests do not match, the control unit 200 may determine that the software component under authentication may be corrupted or fraudulent and game play may be halted. It should be appreciated that the control unit 200 may perform other suitable security and authentication checks on the game data or software components. Such authentication and security devices and functions are unique to gaming and casino industry to minimize or prevent fraud in gaming devices and gaming systems.

For a player to interact with a gaming device, the control unit 200 receives and processes player inputs, and the control unit 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for the attached input devices and output devices. In this manner, specially configured processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 208 for game play. Alternatively, a player deposits value into a gaming device by inserting an encoded paper ticket into a value acceptor 208 for game play in some implementations. The value acceptor 208 can be combined with a currency reader and validator, and a code reader for reading value encoded on paper tickets. The value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming system 100. During game play, the specially configured processor 202 processes a player's wagers and determines the amount of credits to debit from the player's credit balance. When a winning outcome is obtained, the specially configured processor 202 is configured to determine the amount of credits to add to the player's credit balance.

As previously mentioned with respect to FIG. 1, a variety of value acceptance arrangements are possible. In some implementations, the value acceptor 208 could include magnetic strip or chip card readers to accept and transfer value. The value acceptor 208 may also be configured to accept and transfer non-traditional currencies such as digital currencies. In these implementations, I/O controller 206, a specially configured processor 202, or both contain appropriate control instructions to communicate and extract value from the inserted item containing value. In some implementations, use of a magnetic strip or embedded chip card, for example a bank card, for value insertion requires the specially configured processor 202 to communicate, via network interface controller 224 (described below), with devices external to a gaming device.

In some implementations, a card reader 210 may be included in gaming system 100 to accept player loyalty cards. For example, card reader 210 can extract account identifying information from the card and utilizes this information to access the associated account information stored remotely via network interface controller 224. In implementations where player loyalty/player tracking systems are employed, a player's loyalty account and record of gaming activity can be stored in a networked storage location or database. The specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various implementations, a player control 212 receives a player's game inputs and communicates the player's game inputs to the specially configured processor 202. The player's game inputs may include, but are not limited to, wager amounts, pay line selections, game control signals, and cash-out signals. The player control 212 may generate signals based on button presses, touch screen activations, or voice control. The player-initiated signals are propagated to the specially configured processor 202 by the I/O controller 206. Further, the player-initiated signals may direct and inform execution of the game instructions stored in the memory device 204 and configured to be executed by the specially configured processor 202.

In some implementations, the specially configured processor 202 is configured to execute stored program code and instructions which generate random numbers or pseudo-random numbers. In some implementations, as illustrated in FIG. 2, a random number generator (RNG) 214 is a software module configured to be executed by the specially configured processor 202 for the generation of a true random or pseudo-random number. The code for RNG 214 may be stored in the memory device 204. The RNG 214 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 214, patterns of symbols are compared to determine wagering outcomes. In an alternative implementation, gaming system 100 may include a hardware based random number generator that is in communication with specially configured processor 202 to supply random numbers for game generation purposes. The hardware based random number generator may be incorporated into specially configured processor 202 or can be separate from specially configured processor 202.

In yet another implementation, the random generation of “numbers” or symbols may be performed with electro-mechanical components. For example, gaming devices such as gaming system 100 may incorporate a mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electro-mechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the control unit 200 controls the function and output of a output devices utilized by a gaming device. In various implementations, I/O controller 206 serves as an interface unit between specially configured processor 202 and output devices such as video processor 216, cabinet lighting controller 218, audio controller 220, and value dispenser 222.

In some implementations, the video processor 216 communicates with specially configured processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with specially configured processor 202. In certain implementations which utilize sound design, specially configured processor 202 may utilize audio controller 220 to coordinate and control the sound emissions. In some implementations, audio controller 220 may include one or more audio processing cards for generating sound and for driving the one, two or more speakers that may be included with a gaming device.

In various implementations, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the specially configured processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the control unit 200 may communicate with one or more devices outside the gaming device. For example, gaming system 100 may be connected to a larger network 240 via a local area network (LAN) or a wide area network (WAN). The control unit 200 may communicate with one or more central servers, controllers, or remote devices to execute games, establish credit balances, participate in jackpots, etc. In such implementations, network communications and connections are accomplished via a network interface controller 224. Network interface controller 224 can be a digital circuit board or card installed in control unit 200 to provide network communications with external devices.

In some implementations, various additional features and functions are performed by the control unit 200. For example, the control unit 200 may be specially configured with appropriate software to track all game play events that occur on a gaming device. In some implementations, the control unit 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

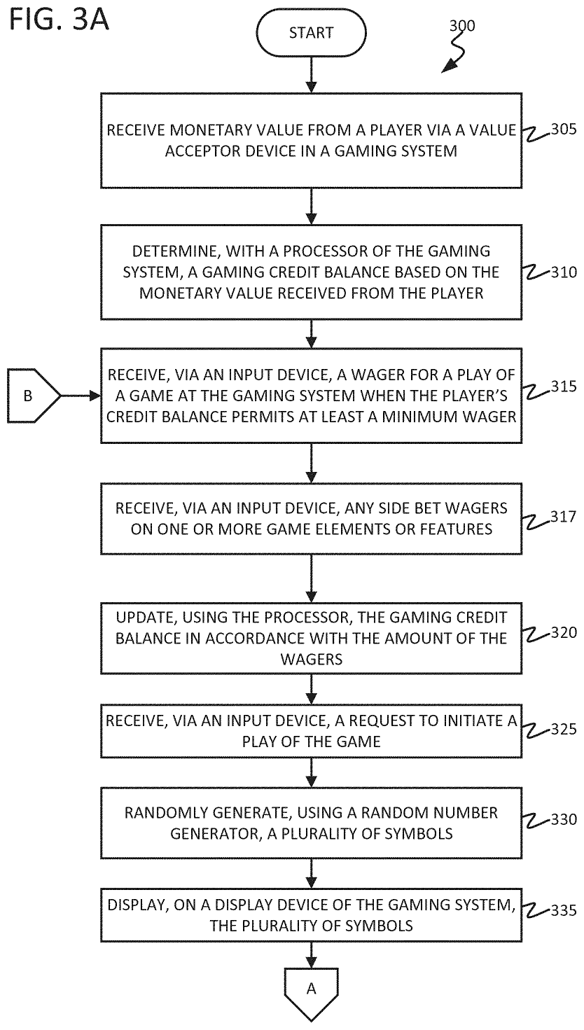

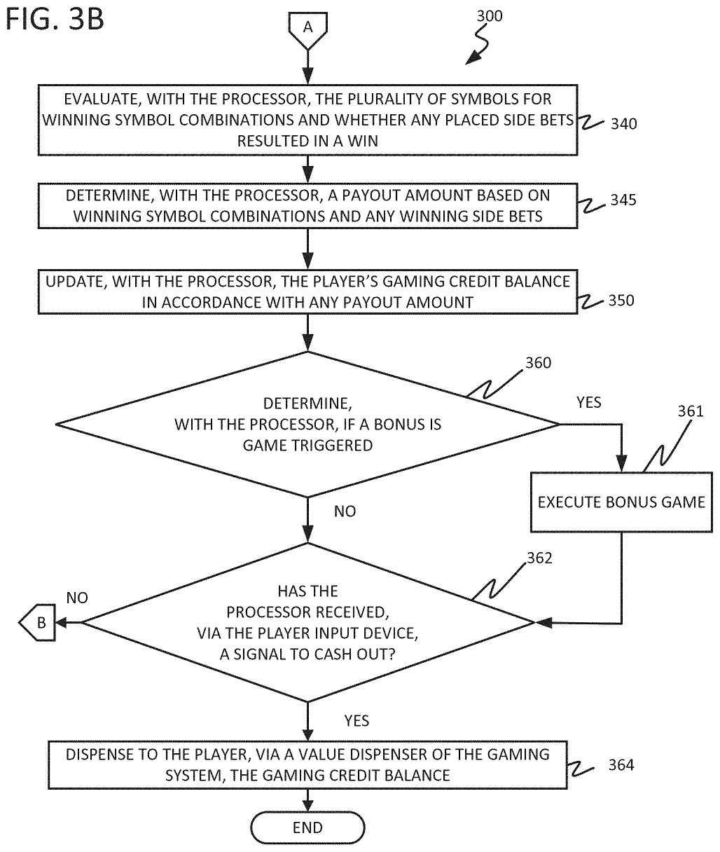

The flowcharts in FIGS. 3A and 3B illustrate functionality and operation of possible implementations of systems, devices, methods, and computer program products according to various implementations of the present disclosure. Each block in the flow diagrams of FIGS. 3A and 3B can represent a module, segment, or portion of program instructions, which includes one or more computer executable instructions for implementing the illustrated functions and operations. In some alternative implementations, the functions and/or operations illustrated in a particular block of the flow diagram can occur out of the order shown in FIGS. 3A and 3B. For example, two blocks shown in succession can be executed substantially concurrently, or the blocks can sometimes be executed in the reverse order, depending upon the functionality involved. It will also be noted that each block of the flow diagram and combinations of blocks in the block diagram can be implemented by special purpose hardware-based systems that perform the specified functions or acts, or combinations of special purpose hardware and computer instructions. In some implementations, flowchart can include more blocks or fewer blocks.

FIGS. 3A and 3B show a process flowchart illustrating an example of operation 300 of operating the gaming system (e.g., gaming system 100) providing side bet wagers on one or more game elements or features in accordance with aspects of the present disclosure.

In some implementations, one or more processors (e.g., processor 202) of the gaming system are configured, via instructions (e.g., gaming module) stored in a memory device (e.g., memory 204 or a storage system), to perform the operation 300. In block 305, the gaming system receives monetary value via a value acceptor device (e.g., value acceptor 208). In block 310, the gaming system determines a credit balance based on the monetary value received from the player in block 305 at the value acceptor device. In block 315, the gaming system receives a wager for a play of a game from a player via an input device (e.g., player control 212) using, e.g., the credit balance determined at block 310.

In some implementations, the gaming system allows the player to place a minimum wager, a maximum wager, or any suitable wager amount. In some implementations, the player's wager amount may determine the value of some of the available awards. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines. In some implementations, the gaming system determines whether the credit balance determined at block 315 includes enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

At block 317, the gaming system may receive any side bet wagers on one or more game elements or features from a player via an input device (e.g., player control 212) using, e.g., the credit balance determined at block 310. In some implementations, the gaming system determines whether the credit balance determined at block 310, as modified to reflect the primary wager placed in block 315, includes enough credits to enable the player's selected side bet wager in block 317. The gaming system may prevent the player from placing the side bet wager if the player's credit balance is not large enough to support the player's selected side bet wager. If enough credits are not available in the player's credit balance, the gaming system may enable the player to insert additional value to obtain the minimum credit level, play the game based on the wager received in block 315, or cash out of the gaming system.

In various side bet implementations discussed herein, the gaming system may provide a game with or without a standard wagering option that can be used with one or more of the various side bet implementations. For example, in some implementations, the gaming system provides the player with a slot reel base game that accepts wagers on pay lines or based on ways pays (e.g., the standard wagering options), and enables the player to place one or more side bets along with the standard wagering options for the slot reel game in block 317.

For example, at block 317, the gaming system in some implementations may display one or more selectable side bet symbols that the player can select for a side bet. In some implementations, the selectable side bet symbols are selected from symbols that are used in a game (e.g., a slot reel game, keno, bingo, social games, casual games, or any other suitable games). In some implementations, selectable side bet symbols may be displayed with a required wager and an associated side bet award for winning the side bet.

In some implementations, the gaming system may enable a player to select from any number of symbols to be selectable side bet symbols. In some implementations, the gaming system provides a selectable side bet symbol set including a plurality of side bet symbols that the player can review and select for one or more side bets. In some implementations, the selectable side bet symbol set may include all of the symbols that the gaming system uses for an associated game. In some implementations, the selectable side bet symbol set may include fewer than all of the symbols that the gaming system uses for an associated game.

In some implementations, by limiting the selectable side bet symbols to include fewer than all of the symbols that the gaming system uses for an associated game, the efficiency of the gaming system can be improved because less memory and less processing power is used during the gaming system's execution for each round/play of the game since the gaming system may need to evaluate fewer symbols for the side bets. This efficiency also translates into faster game play because less time is used to complete the game's evaluation. When such efficiency improvements are made and applied to the hundreds and thousands of game evaluations that are made on a casino floor for the disclosed gaming system, the new gaming system will provide casino game operators sizable gains in machine efficiency, which is a technological improvement.

In some implementations, the gaming system provides multiple options for side bets. For example, the gaming system may display one or more selectable side bet symbols to the player for the player's selection in some implementations. In some implementations, the gaming system displays three selectable side bet symbols to the player for selection. It should be appreciated that the gaming system can display any suitable number of selectable side bet symbols as selection options.

In some implementations, the gaming system may display the selectable side bet symbols below a main game screen area (e.g., below slot reels). In alternative implementations, the gaming system may display the selectable side bet symbols in any suitable area of a game screen. In some implementations, the gaming system may display the selectable side bet symbols in display devices different from a display device displaying a main game screen. In some implementations, the gaming system may display the selectable side bet symbols in a programmable button deck of the gaming system. In some implementations, the gaming system may enable the player to select any symbol displayed in any symbol display area (e.g., symbols generated for a previously played game, symbols displayed in other areas of game screen, etc.) to place a side bet wager.

In block 317, a gaming system in some implementations may keep one or more player selected side bet wagers active until the player makes a different side bet selection or stops/deactivates one or more of the player selected side bets. For example, in some implementations, the gaming system may display multiple selectable side bet symbols. When a player selects one or more of the multiple selectable side bet symbols, the gaming system automatically collects a side bet wager on the selected side bet symbol for more than one play of a game (e.g., keeping the side bet wager active for multiple plays of the game). In some implementations, the gaming system may keep the side bet wager active in additional plays of the game until the player runs out of credits to wager or until some other suitable triggering event occurs. In some implementations, the gaming system may keep the side bet wager active for a predetermined quantity of plays of a game (e.g., three plays of a game or some other suitable number of plays of a game).

In block 317, the gaming system in some implementations may change the available selectable side bet symbols in different plays of a game. In some implementations, the gaming system changes one or more available selectable side bet symbols every new play of the game. For example, in some implementations, the one or more available selectable side bet symbols can be randomly changed (e.g., so that different symbols can be offered for a side bet). In some implementations, the gaming system changes one or more available selectable side bet symbols after a predetermined quantity of plays of a game. In some implementations, the gaming system changes one or more available selectable side bet symbols after a randomly generated number of plays of a game.

In block 317, the gaming system in some implementations may enable a player to select from any number of symbols to be selectable side bet symbols. In some implementations, the gaming system provides a selectable side bet symbol set including a plurality of side bet symbols that the player can review and select for one or more side bets. In some implementations, the selectable side bet symbol set may include all of the symbols that the gaming system uses for an associated game. In some implementations, the selectable side bet symbol set may include fewer than all of the symbols that the gaming system uses for an associated game. In some implementations, the gaming system may present a predetermined quantity of the side bet symbols in the selectable side bet symbol set in a pop out or slide out window (e.g., a slide out information area) of a game screen. The gaming system may enable the player to scroll through available selectable side bet symbols within the slide out information area. In some implementations, a slide out information area also provides the player with symbol pay table information. In some implementations, the slide out information area provides the player with other suitable game information such as side bet wager information, side bet award information, jackpot information, player tracking information, awards, offers, etc.

In block 317, the gaming system in some implementations may enable the player to place side bet wagers on one or more pay lines. In some implementations, the gaming system may enable the player to select any available pay line for a side bet wager. In other implementations, the gaming system provides a predetermined quantity of pay lines (e.g., fewer than the total amount of available pay lines) that are available for a side bet wager. For example, in some implementations, the gaming system may enable a player to place a side bet wager on pay line number 5 of 50 pay lines in a game. In such an example, if the gaming system generated a winning symbol combination on pay line number 5, the player may win the award associated with the winning symbol combination on pay line number 5 (e.g., the standard game award associated with a pay table) as well as winning the side bet wager on pay line number 5.

In some implementations, by limiting the selectable pay lines for side bet wager to include fewer than all of the total amount of available pay lines, the efficiency of the gaming system can be improved because less memory and less processing power is used during the gaming system's execution for each round/play of the game since the gaming system may need to evaluate relatively fewer pay lines for the side bets. This efficiency also translates into faster game play because less time is used to complete the game's evaluation of the side bet wagers. When such efficiency improvements are made and applied to the hundreds and thousands of game evaluations that are made on a casino floor for the disclosed gaming system, the new gaming system will provide casino game operators sizable gains in machine efficiency, which is a technological improvement.

In some implementations, the gaming system in block 317 may enable the player to place a side bet wager on a non-traditional pay line. For example, if a slot reel game includes pay lines that evaluate and pay from a far left reel to a far right reel, the gaming system may offer the player side bets on one or more pay lines that pay from right to left or that are evaluated from reels other than the far left reel or the far right reel (e.g., a center of reel of a plurality of reels). In some implementations, these non-traditional pay lines that are available for a side bet wager are predetermined and the player can select from an available list of non-traditional pay lines. In some implementations, gaming system enables the player to pick the player's own non-traditional pay line. For example, in some implementations, the gaming system enables a player to draw a custom pay line. In some implementations, the gaming system may enable the player to pick the start and the end of a pay line anywhere in a game. In some implementations, the pay line may start evaluating winning symbol combinations in the center of reels or symbol display areas. In some implementations, custom player drawn pay lines may have minimum number of symbols display areas and reels that must be included in the player's unique pay line. In some implementations, if a winning symbol combination is generated on the player's unique pay line, the player wins the side bet. The gaming system may vary side bet awards based on the quantities of symbols in a pay line or aspects of the pay line design.

In some implementations, the gaming system in block 317 may enable a player to select different custom winning symbol combinations for a side bet wager. In some implementations, the gaming system may dynamically determine at the time of player selection of symbols that form a winning symbol combination, what the side bet award can be based on the statistical likelihood of the gaming system generating the selected symbols and the return to player value required at the gaming system.

In some implementations, the gaming system in block 317 may enable a player to select one or more symbol display areas and place a side bet wager that the gaming system will generate a particular symbol in the selected one or more symbol display areas during one or more plays of a game.

At block 320, the gaming system updates the credit balance determined at 310 in accordance with the amount(s) wagered at 315 and/or 317.

At block 325, the gaming device receives a request to initiate a play of the game via the input device. For example, the player may press a spin button on the gaming system to start spinning slot machine reels of the gaming system (e.g., or randomly generating symbols using other methods discussed above for virtual reels) for the play of the game. In some implementations, a play of a game begins with a wager and activation of a game and the play of the game ends when the features of the base, bonus, or both have completed (e.g., depending on whether a bonus game is played). In another implementation, one play of a game comprises the processor executing blocks 315-361 and terminating at either block 360 or 361 depending on whether the gaming system activates a bonus game. In some implementations, block 362 and block 364 are not part of a play of a game. In alternative implementations, block 362 and block 364 are part of a play of a game.

It should be appreciated that reels or slot machine reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

At block 330, the gaming system randomly generates, using a random number generator (e.g., random number generator 214) game symbols for at least one reel of the gaming system from one or more symbol sets.

In some implementations, the gaming system may generate symbols for display on at least one reel. In some implementations, the gaming system may generate the symbols for display on a set of reels. In some such implementations, the reels are associated with respective symbol sets. In some implementations, each reel is associated with one of the symbol sets. At block 335, the gaming system causes a display device (e.g., first display device 120) to display the symbols generated at 330. For example, in a game using reels, the gaming system may display the generated symbols in visible symbol display areas of the individual reels.

Turning now to FIG. 3B and off page connector A, in some implementations as shown in block 340, the gaming system evaluates the generated symbols across active or wagered pay lines for winning symbol combinations and evaluates whether any placed side bets resulted in wins. In block 345, the gaming system determines, with the processor, a payout amount based on the evaluated winning symbol combinations across wagered pay lines.

In some implementations, the gaming system evaluates the winning symbol combinations based on the pay lines wagered upon by a player in block 315 and/or any additional pay lines associated with a side bet by the player in block 317. The gaming system may evaluate the player selected pay lines, gaming system assigned pay lines, or pay lines assigned as active in some other manner for the play of the game. In block 345, the gaming system in some implementations may determine an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, two or more symbols may be used to form winning symbol combinations that result in a payout for a traditional wager (e.g., the wager from block 315) or a side bet wager (e.g., the wager from block 317).

As previously described with respect to block 317, the gaming system in some implementations may enable a player to select different custom winning symbol combinations for a side bet wager. In block 340, the gaming system in some implementations may evaluate one or more active pay lines for the custom winning symbol combinations. In some implementations, the gaming system may dynamically determine at the time of player selection of symbols that form a winning symbol combination, what the side bet award can be based on the statistical likelihood of the gaming system generating the selected symbols and the return to player value required at the gaming system.

In some implementations, the gaming system may use other methods to determine winning symbol combinations in addition to or without pay lines to evaluate the tradition wager or any side bet wagers in block 340. For example, the gaming system may evaluate generated and displayed symbols for scatter pay symbols, ways pays, etc. In some implementations with ways pays, the gaming system can determine a payout amount based on the gaming system generating one or more predetermined symbols on consecutive reels where the predetermined symbols are displayed on adjacent reels. In some implementations with way pays, the gaming system does not require pay lines or pay line selections.

In some implementations, a side bet wagered in block 317 is associated with selectable side bet symbols that are used in a slot reel game or other suitable games, and gaming system in block 340 determines that the player wins the side bet associated with a selected symbol when the gaming system generates one or more of the selected symbols in a winning symbol combination. In some implementations, a player selected symbol for a side bet is a win when the player selected symbol appears as part of a winning scatter symbol combination. In various implementations, the gaming system may determine in block 340 that a selectable side bet symbol resulted in win when a player selected the selectable side bet symbol and the gaming system generated such side bet symbol during a play of a game when the side bet was active.

As previously described, the gaming system in some implementations may enable the player to place side bet wagers on one or more particular pay lines in block 317. In block 340, the gaming system in some implementations evaluates the generated symbols across one or more pay lines associated with a side bet wager for winning symbol combinations and evaluates whether any placed side bet wagers resulted in wins. For example, in some implementations, the gaming system may enable a player to place a side bet wager on a particular pay line in a game and if the gaming system generated a winning symbol combination on the particular pay line, the player may win the award associated with the winning symbol combination (e.g., the standard/traditional award associated with a pay table) as well as winning the side bet.

As previously described, the gaming system in some implementations may enable the player to place side bet wagers on one or more user defined pay lines or non-traditional pay lines in block 317. For example, if a slot reel game includes pay lines that evaluate and pay from the far left reel to the far right reel, the gaming system may offer the player side bets on one or more pay lines that pay from a right reel to a left reel or that are evaluated from the center of the reels. In block 340, the gaming system in some implementations may evaluate the generated symbols across the non-traditional and/or user-defined pay lines associated with a placed side bet wager for winning symbol combinations. In some implementations, if a winning symbol combination is generated on the player's non-traditional or user-defined pay line, the player wins the side bet. The gaming system may vary side bet awards determined in block 345 based on the quantities of symbols in a pay line or the design of the pay line.

As also described above with respect to block 317, the gaming system in some implementations enables a player to select one or more symbol display areas and place a side bet wager that the gaming system will generate a particular symbol in the selected one or more symbol display areas during the next play of the game. In block 340, the gaming system in some implementations may determine that the player has won a side bet wager based on whether the particular symbol was generated in the selected one or more symbol display areas during the play of the game.

While numerous ways to evaluate side bet wagers are discussed herein, it should be appreciated that with respect to block 340, the gaming system may determine whether any placed side bets result in wins based on the side bet wager the player placed at the gaming system.

As illustrated in block 350, the gaming system may update, with the processor, the player's gaming credit balance in accordance with any award amount. As noted above, the blocks illustrated in FIGS. 3A and 3B can be rearranged in any suitable order. As such, it should be appreciated that the gaming system may update the player's gaming credit balance at other suitable times.

In some implementations, as illustrated in block 360, the gaming system evaluates whether a bonus game is triggered. For example, the gaming system may include or be in communication with a bonus controller. The bonus controller may randomly determine or determine based on a predetermined triggering event (e.g., quantity of games played) to trigger or activate a bonus game. The bonus controller can determine that the bonus game should be triggered using other suitable triggering events (e.g., how long a player has played the game, a time period since the last bonus game was triggered, etc.). In alternative implementations, the gaming system may evaluate the symbols for at least one symbol designated to trigger a bonus game.

If the gaming system determined that a bonus game is not triggered, in block 360, operation 300 moves to block 362. In some implementations, as indicated in block 362, the gaming system may receive a signal to end game play or “cash out” via an input device of the gaming system (e.g., which would end the gaming session). In such a situation, the gaming system dispenses a value to the player, through a value dispenser, based on the player's gaming credit balance as illustrated in block 364 and operation 300 ends.

On the other hand, if the gaming system processor has not received a signal to end game play (e.g., the player continues a gaming session to play another play of the game) via the player input device, the process of operation 300 returns to block 315 via off page connector B. The gaming system may receive, via a player input device, a wager for another play of the game and continue operation 300 from block 315. However, in some implementations, the wager may not be accepted if the player has fewer credits than the player's selected wager amount, as shown in block 315.

Returning now to block 360, if the gaming system determined that a bonus game is triggered (e.g., based on a message from the bonus controller, or due to some other suitable trigger), operation 300 moves to execute the bonus game in block 361, and process 300 may return to block 362 after the bonus game is completed. It should be appreciated that any suitable bonus game can be executed.

In some implementations, the gaming system may enable the player to place side bet wagers on various game features and game elements in the bonus game. In some implementations, the side bet wagers may result in larger awards than awards for side bet wagers from the base game. In some implementations, the available side bets in the bonus game can be the same as the available side bets in the base game. In some implementations, at least some of the available side bets in the bonus game can be different from the available side bets in the base game. In some implementations, all of the available side bets in the bonus game are different from the available side bets in the base game. In some implementations, the player can place a side bet wager on whether a bonus game is triggered. The gaming system may evaluate and provide an award for this side bet wager when the bonus game is triggered. In some implementations, the player may place one side bet wager in the base game that is evaluated for an award in both the base game and the bonus game. In some implementations, such a side bet wager evaluated in both the base game and bonus game is associated with different awards between the base game and the bonus game. In some implementations, where the one side bet wager evaluated in both the base game and bonus game, the award for the side bet wager in the bonus game is larger than the award for the side bet wager in the base game. In some implementations, where the one side bet wager evaluated in both the base game and bonus game, the award for the side bet wager in the bonus game is smaller than the award for the side bet wager in the base game.

In some implementations, the gaming system enables the player to place side bet wagers at the start of the bonus game (e.g., at block 361) for game features and game elements in the bonus game. In some implementations, the gaming system enables the player to place side bet wagers for game features and/or game elements in the bonus game at some time before or after the bonus game is triggered. In some implementations, the awards available for side bet wagers in the bonus game are larger when the player places such side bet wagers before the bonus game is triggered than when the player places a side bet wager after the bonus game is triggered. In some implementations, the gaming system requires the player to place side bet wagers for game features and/or game elements in the bonus game at some time before the bonus game is triggered.

In some implementations, as indicated in block 362, the gaming system may receive a signal to end game play or “cash out” via an input device of the gaming system (e.g., which may end the gaming session). In such a situation, the gaming system dispenses a value to the player, through a value dispenser, based on the player's gaming credit balance as illustrated in block 364 and operation 300 ends.

On the other hand, if the gaming system processor has not received a signal to end game play (e.g., the player continues a gaming session to play another play of the game) via the player input device, the process of operation 300 returns to block 315, as indicated by off-page connector B. The gaming system may receive, via a player input device, a wager for another play of the game and continue operation 300 from block 315. However, in some implementations, the wager may not be accepted if the player has fewer credits than the player's selected wager amount, as shown in block 315.

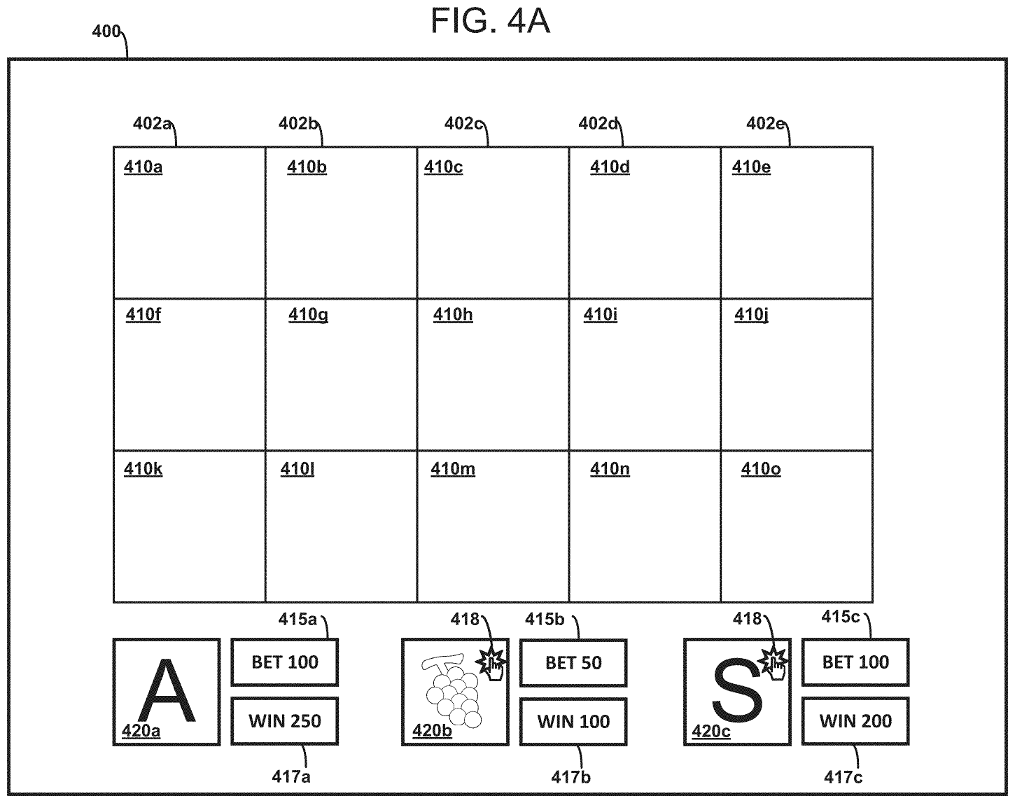

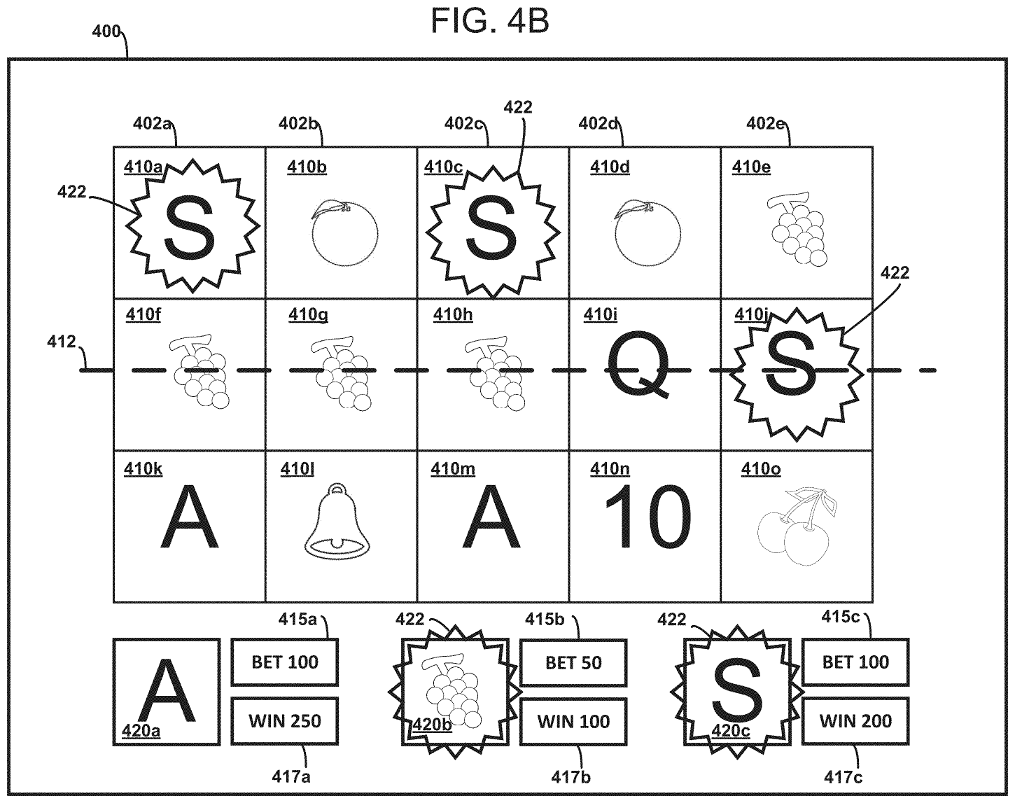

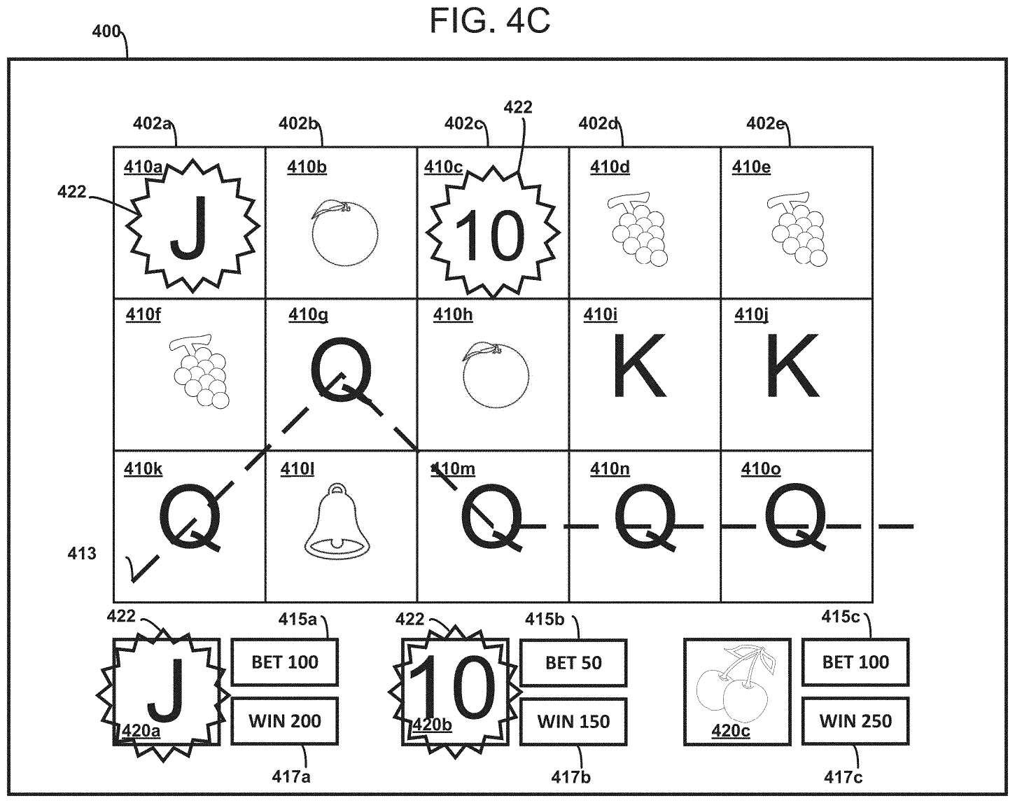

FIGS. 4A-4C show screen shots of one or more gaming system displays illustrating example side bet implementations in accordance with aspects of the present disclosure.

FIG. 4A illustrates one implementation of a game screen 400 that the gaming system 100 may display on a display device of the gaming system. In some implementations, game screen 400 may be displayed on display device 120 of gaming system 100 illustrated in FIG. 1. However, any other suitable display device may be used. The game screen 400 displays a set of a virtual video slot machine reels 402a, 402b, 402c, 402d, and 402e as illustrated in FIG. 4A for a primary or base game. As also illustrated in FIG. 4A, the reels 402a-402e may be displayed substantially side by side. It should be appreciated that reels 402a-402e can be displayed with any suitable amount of separation or no separation. It should be appreciated that the game shown in game screen 400 is merely representative and may have more or fewer game elements (e.g., reels, symbol display areas, symbols, images, etc.) shown in the game screen 400. It should also be appreciated that other games may be used for the primary or base game.

In some implementations, the reels 402a-402e are each respectively associated with a set of symbols or a symbol set, where each set of symbols includes a number of symbols. The sets of symbols can be associated with the same or different symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the set of symbols may include pay symbols, scatter symbols, and special or designated symbols.

In some implementations, at least one predetermined symbol is a triggering symbol for a bonus game. However, in some implementations, a bonus game is triggered in alternative ways. In one such alternative implementation, a bonus game can be triggered by a bonus controller in communication with the gaming system. In some implementations, the bonus controller randomly generates and outputs a bonus game triggering signal that the gaming system uses to trigger a bonus game. In some implementations, the bonus controller outputs a bonus game triggering signal based on one or more different statistics, such as how much a player has wagered, how long the player has played games on the gaming system, etc. In some implementations, at least one triggering symbol must be generated on the reels during a play of a game to trigger the bonus game. In some implementations, multiple triggering symbols must be generated on the reels during a play of a game to trigger the bonus game. In some implementations, any one of the symbols in the symbol sets can be designated as the predetermined triggering symbol. The triggering symbol may be associated with one function (e.g., triggering a bonus game), but may alternatively be associated with a plurality of different game functions. The triggering symbol may be a scatter symbol in some implementations.

Returning to FIG. 4A, the game screen 400 depicts a plurality of symbol display areas (also referred to herein as symbol display positions) 410a-410o. These plurality of symbol display areas can be associated in a manner that provides the appearance of game reels. It should also be appreciated that the symbol display areas may not be associated with game reels in some implementations. As illustrated in FIG. 4A, symbol display areas 410a-410o may be positioned in a manner that provides the appearance of a set of five slot machine game reels. In some implementations, the plurality of symbol display areas that provide the appearance of five game reels may be arranged in a manner that visibly shows three symbol positions of each of the five game reels. For example, the symbol display areas 410a-410o may be each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e.

The arrangement illustrated in the implementation of FIG. 4A thus creates a visible display area of the reels 402a-402e comprising three visible symbol positions for each reel. When viewed together, reels 402a-402e appear like a 3-row by 5-column reel array in game screen 400. In various implementations, the gaming system may be configured to include fewer reels or more reels. In some implementations, smaller or larger visible areas of the reels can be displayed. That is, the reels 402a-402e may show fewer or a larger number of visible symbol display areas. In some implementations, some symbol display areas can be hidden to hold generated symbols for use when the reels are nudged. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels.

Reels 402a-402e may display a plurality of symbols that the gaming system generates from the sets of symbols in their respective symbol display areas. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict reels or spinning symbols.

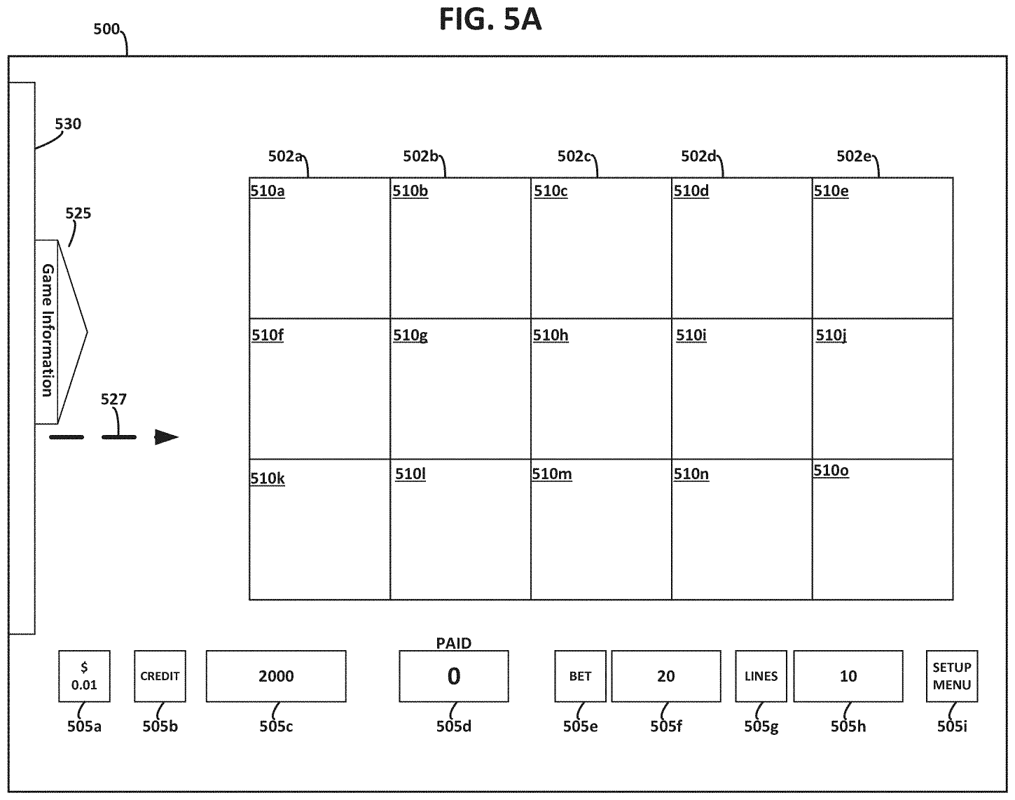

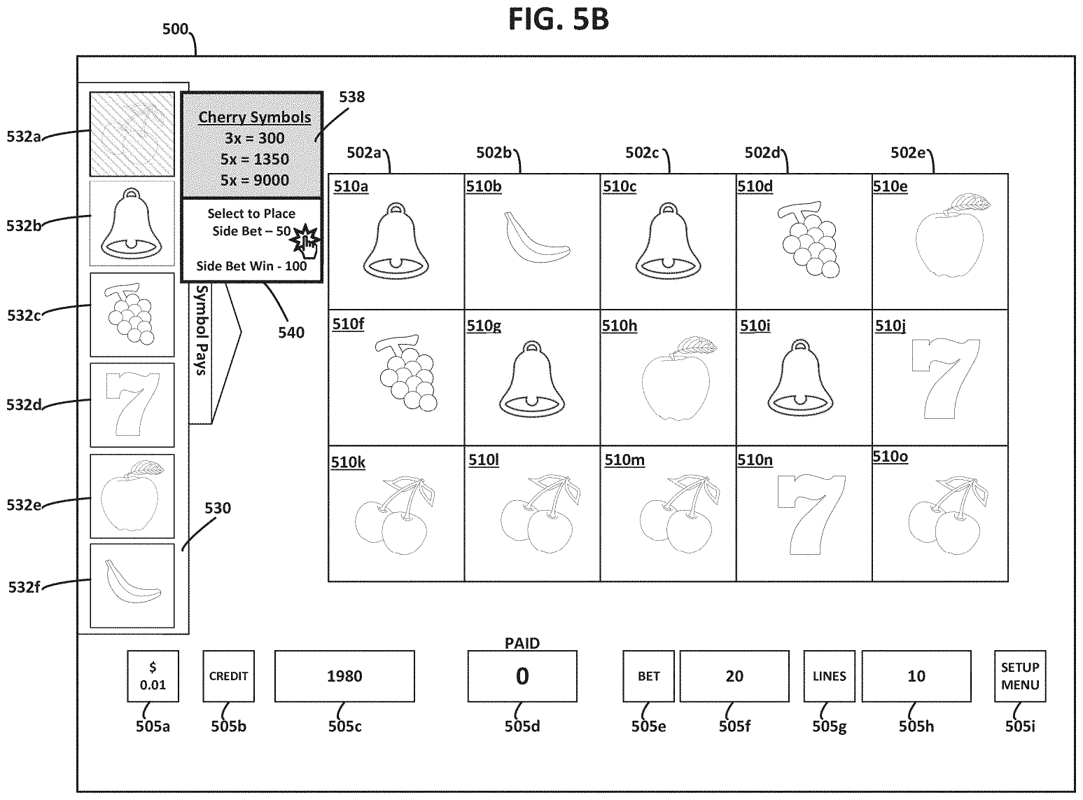

Continuing with FIG. 4A, the game screen 400 may also include side bet information areas 415a-415c and 417a-417c and side bet symbol buttons 420a-420c. Side bet information areas 415a-415c and 417a-417c and side bet symbol buttons 420a-420c are illustrated in a particular arrangement but may be arranged in any suitable manner in different implementations. In the example shown in FIG. 4A, the game screen 400 displays three side bet symbol buttons 420a-420c to the player for selection, but it should be appreciated that the gaming system can display any suitable number of selectable side bet symbols as selection options. In some implementations, game screen 400 may include more or fewer side bet information areas 415a-415c and 417a-417c and side bet symbol buttons 420a-420c than illustrated. In some implementations, the gaming screen 400 may include other suitable information areas (e.g., FIG. 5A includes examples of other suitable information areas).

The side bet symbol buttons 420a-420c may display one or more selectable side bet symbols that the player can select (e.g., selections 418) for one or more side bet(s). In some implementations, the gaming system may provide the selectable side bet symbols from symbols that are used in a game (e.g., a slot reel game or other suitable games). In some implementations, the gaming system may enable a player to select from any number of symbols to be selectable side bet symbols. In some implementations, the gaming system provides a selectable side bet symbol set including a plurality of side bet symbols that the player can review and select for one or more side bets. In some implementations, the selectable side bet symbol set may include all of the symbols that the gaming system uses for an associated game. In some implementations, the selectable side bet symbol set may include fewer than all of the symbols that the gaming system uses for an associated game.

In the example shown in FIG. 4A, side bet symbol button 420a displays an Ace (“A”) symbol; side bet symbol button 420b displays a Grape symbol; and side bet symbol button 420c displays a Scatter (“S”) symbol. In some implementations, the gaming system randomly generates and displays symbols from the selectable side bet symbol set for side bet symbol buttons 420a-420c. In some implementations, the gaming system randomly generates and displays the symbols for the side bet symbol buttons 420a-420c before or during the start of the game. FIG. 4A shows that the player made selections 418 of the side bet symbol button 420b displaying the Grape symbol, and side bet symbol button 420c displaying the Scatter symbol. As described in greater detail below, the particular symbols displayed in the side bet symbol buttons 420a-420c may vary during different plays and/or may be specified by a user.

A selection 418 may be associated with an input received from the player with respect to one or more of the selectable side bet symbols, such as a user input identifying one or more of the side bet symbol buttons 420a-420c. For example, a player may press a touch screen input device on or near side bet symbol button 420c in some implementations. In some implementations, the player may press a mechanical button (e.g., input device 115) that is associated with side bet symbol button 420c. in some implementations. It should be appreciated that the gaming system may receive input from the player with respect to one or more of the selectable side bet symbols in any suitable manner. In some implementations, when the player selects a side bet symbol button, the gaming system automatically deducts a side bet wager amount associated with the selected side bet symbol. Thus, in some implementations, a single selection at the gaming system allows a player to efficiently select a desired symbol and to place a side bet wager simultaneously, without having to perform multiple steps to place a side bet wager.

In some implementations, a gaming system may keep a particular player selected side bet active until player makes a different side bet selection or stops/deactivates the particular player selected side bet. For example, in some implementations, the gaming system may display multiple selectable side bet symbols, and when a player selects one or more of the multiple selectable side bet symbols, the gaming system automatically collects a side bet wager on the selected side bet symbol for more than one play of a game (e.g., keeping the side bet wager active for multiple plays of the game). For example, the game screen 400 may continue to display in indication of a selection 418 of one of the selectable side bet symbols. In some implementations, the gaming system may keep the side bet wager active (e.g., continue to make the selection 418) until the player runs out of credits to wager. In some implementations, the gaming system may keep the side bet wager active for a predetermined quantity of plays of a game (e.g., three games or some other suitable number of games).

In some implementations, the gaming system automatically makes selection 418 of one or more of the side bet symbol buttons 420a-420c (e.g., without receiving a player input) for the player. In some implementations, the player may indicate that the player wishes to make one or more side bets on symbols and chooses to allow the gaming system to select one or more available symbols for side bet wagers. In some implementations, the gaming system may provide an award of a free side bet, as an award in a prior play of the base game or based on one or more different player statistics, such as how much a player has wagered, how long the player has played games on the gaming system, etc. In some such implementations, the gaming system may automatically place free side bet wagers for the player and automatically select one or more game elements or game features for the one or more side bets.

In some implementations, the game screen 400 may display side bet symbol buttons 420a-420c with a required wager in side bet information areas 415a-415c and an associated side bet awards in side bet information areas 417a-417c. The side bet information area 415a-415c identify respective wager amounts that the gaming system automatically collects in response to one or more selections 418 of the side bet symbol buttons 420a-420c, and side bet information area 417a-417c identify respective winning amounts that the gaming system automatically credits to the player for a winning side bet associated with a selected side bet symbol. The gaming system may also display other suitable information related to side bets.

In the example shown in FIG. 4A, side bet symbol button 420a (displaying an Ace symbol) is associated with a side bet information area 415a identifying a required wager of 100 credits and side bet information area 417a identifying a side bet award of 250 credits; side bet symbol button 420b (displaying a Grape symbol) is associated with a side bet information area 415b identifying a required wager of 50 credits and side bet information area 417b identifying a side bet award of 100 credits; and side bet symbol button 420c (displaying a Scatter symbol) is associated with a side bet information area 415c identifying a required wager of 100 credits and side bet information area 417c identifying a side bet award of 200 credits.

In the game screen 400 in FIG. 4A, the gaming system displays the side bet information areas 415a-415c and 417a-417c and the side bet symbol buttons 420a-420c below a main game screen area (e.g., below slot reels 402a-402e). In alternative implementations, the gaming system may display one or more of the side bet information areas 415a-415c and 417a-417c and/or the side bet symbol buttons 420a-420c in any suitable area of the game screen 400. In some implementations, the gaming system may display the side bet information areas 415a-415c and 417a-417c and/or the side bet symbol buttons 420a-420c in one or more display devices (e.g., second game display device 130 and/or third game display device 134) different from a display device (e.g., first game display device 120) displaying a main game screen (e.g., game screen 400 showing slot reels 402a-402e). In some implementations, the gaming system may display the selectable side bet symbols in a programmable button deck of the gaming system (e.g., input devices 115).

The gaming system may determine that the player wins a side bet associated with a selected side bet symbol when the game system generates the selected side bet symbol during the game (e.g., the selected side bet symbol appears in appropriate one or more of the symbol display areas 410a-410o, such as along a pay line). For example, FIG. 4A shows player selections 418 of a Grape symbol in the side bet symbol button 420b and a Scatter symbol in the side bet symbol button 420c. As described below with respect to FIG. 4B, the player may win the side bets if the gaming system generates a Grape in a winning symbol combination or generates the Scatter symbol in a winning scatter symbol combination, in some implementations.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on the play of the game.

To initiate the play of the game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also place a side bet, such as selecting one or more side bet symbol buttons 420a-420c, as described above with respect to FIG. 4A. In FIG. 4B, the gaming system displays a game screen 400 after a base or main game (e.g., a slot reel game) is initiated and side bets are received. The player may actuate a game start button, a spin button, or a lever. The gaming system may deduct the appropriate credits from the player's credit balance after the wagers are received or at any suitable time.

In some implementations, the gaming system may use other methods to determine winning symbol combinations in addition to or without pay lines. For example, the gaming system may evaluate generated and displayed symbols for scatter pay symbols, ways pays, etc. In some implementations with ways pays, the gaming system can determine a payout amount based on the gaming system generating one or more predetermined symbols on consecutive reels where the predetermined symbols are adjacent. In some implementations with ways pays, the gaming system does not require pay line selections.

Upon receipt of the player's wagers and activation of the game start button, the gaming system may show a display of spinning reels for each of the reels 402a-402e for the start of a play of the game. The spinning of reels and/or symbols may appear to occur in a vertical top to bottom direction or in a vertical bottom to top direction (not shown), or in a combination of vertical directions (not shown). In some implementations, the gaming system randomly generates symbols from the associated sets of symbols for reels 402a-402e, respectively. As noted above, the gaming system may rely on random generation performed by a pseudo RNG, a true RNG, or hardware RNG specifically designed for wager based gaming systems. In some implementations, the gaming system may also update the player's credit meter to reflect the player's available credit balance, such as to decrement the player's credit meter by a quantity of credits to reflect a credit wager the player placed for the play of the game and one or more additional credit wagers placed for side bets.

The gaming system displays the generated symbols in symbol display areas 410a-410o as illustrated in FIG. 4B. Symbols displayed on reels 402a-402e illustrate the randomly generated symbols from the symbol sets after the reels have stopped spinning. As illustrated in FIG. 4B, the gaming system randomly generated and displayed symbols in symbol display areas 410a-410o for reels 402a-402e.

As illustrated in FIG. 4B, the gaming system generated and displayed Scatter symbols in symbol display areas 410a, 410c, and 410j; Orange symbols in symbol display areas 410b and 410d; Grape symbols in symbol display areas 410e, 410f, 410g, 410h; a Queen (“Q”) symbol in symbol display area 410i; Ace symbols in symbol display areas 410k and 410m; a Bell symbol in symbol display area 410l; a 10 symbol in symbol display area 410n; and a Cherry symbol in symbol display area 410o in the game screen 400. It should be appreciated that the displayed symbol combinations are merely for explanatory purposes and the gaming system may randomly generate any suitable combination of symbols based on defined symbol sets associated with the reels 402a-402e. In the implementation illustrated in FIG. 4B, the gaming system evaluated the generated symbol combinations for winning symbol combinations and for side bets.

In some implementations, the gaming system may execute an evaluation of the generated symbols on reels 402a-402e for winning symbol combinations. As noted above, the player may have wagered on one or more pay lines. In some implementations, at least the active (wagered on pay lines) are evaluated for winning symbol combinations. Any suitable number of pay lines may be used to evaluate winning symbol combinations. The gaming system may provide an award associated with the winning symbol combination of three Grape symbols in pay line 412 in accordance with a pay table (not shown) associated with the base game. The gaming system may also update the player's gaming credit balance or do so at a later time.

The gaming system may further execute an evaluation of the generated symbols on reels 402a-402e for side bets associated with selected side bet symbols.

In some implementations, the gaming system evaluates the generated symbols for winning symbol combinations that include the selected one or more side bet symbols. In the example shown in FIG. 4B, the player had placed a side bet wager on the Grape symbol in side bet symbol selection area 420b. In some implementations, the gaming system evaluated at least the active pay lines (wagered on pay lines) for winning symbol combinations that also include the selected one or more side bet symbols (e.g., the Grape symbol). The gaming system may evaluate any suitable number of pay lines for winning symbol combinations that include the selected side bet symbol (e.g., the Grape symbol).

It should be appreciated that in some implementations, by limiting the evaluation of selected side bet symbols to active pay lines with winning symbol combinations, the efficiency of the gaming system can be improved because less memory and less processing power is used during the gaming system's execution for each round/play of the game since the gaming system may need to evaluate fewer pay lines for symbols for the side bets. This efficiency also translates into faster game play because less time is used to complete the game's evaluation. When such efficiency improvements are made and applied to the hundreds and thousands of game evaluations that are made on a casino floor for the disclosed gaming system, the new gaming system will provide casino game operators sizable gains in machine efficiency, which is a technological improvement.

In some implementations, the gaming system determines that the side bet on the Grape symbol is a winning side bet if the Grape symbol forms a winning symbol combination on an active pay line and is not a winning side bet if the Grape symbol is merely on an active pay line that include other symbols in a winning symbol combination. In some implementations, the gaming system determines that the side bet on the Grape symbol is a winning side bet if the Grape symbol merely appears along an active pay line that also has a winning symbol combination (e.g., the winning symbol combination can be formed from symbols other than Grape symbols). In still other implementations, the gaming system may determine the side bet on the Grape symbol is a winning side bet either if the Grape symbol forms a winning symbol combination on an active pay line or if the Grape symbol merely appears along an active pay line that also has a winning symbol combination. In some such implementations, the gaming system may provide different award values depending on whether or not the Grape symbol forms the winning symbol combination. In some implementations, where the Grape symbol forms the winning symbol combination, the gaming system may provide a high award value than where the Grape symbol merely appears along an active pay line that also has a winning symbol combination.

The gaming system may provide the side bet award associated with the winning symbol combination of three Grape symbols in pay line 412 in accordance with the pay amount identified in side bet information area 417b associated with the Grape symbol. The gaming system may also update the player's gaming credit balance or do so at a later time to reflect the award associated with winning the side bet associated with the side bet selection of the Grape symbol.

In some implementations, the gaming system evaluates the generated symbols for winning scatter symbol combinations that include one or more of the selected side bet symbols. In the example shown in FIG. 4B, the player has placed a side bet on the Scatter symbol in side bet symbol selection area 420c. The gaming system may evaluate the displayed symbols for winning scatter symbol combinations that also include the selected one or more side bet symbols (e.g., the Scatter symbol). In some implementations, the gaming system may determine whether at least a threshold quantity (e.g., 3 or more) of the Scatter symbols are included in the symbol display areas 410a-410o. In the example shown in FIG. 4B, the gaming system determines that the player won the side bet for the Scatter symbol selected in side bet selection area 420c since the Scatter symbol is generated in symbol displays areas 410a, 410c, and 410j. The gaming system may provide the side bet award associated with the winning symbol combination of three Scatter symbols in accordance with the pay amount identified in side bet information area 417c associated with the Scatter symbol. In some alternative implementations, the gaming system may determine that the player won the side bet for the Scatter symbol selected in side bet selection area 420c where as few as one Scatter symbol is displayed in the symbol display areas 410a-410o. The gaming system may also update the player's gaming credit balance or do so at a later time to reflect the award associated with winning the side bet associated with the side bet selection of the Scatter symbol.

In FIG. 4B, the game screen 400 may display a winning side bet symbol indication 422 identifying a winning selected side bet symbol. For example, the gaming system may display the winning side bet symbol indication 422 as graphical shape, text, an image, or other visually distinctive feature identifying a winning selected side bet symbol. In some implementations, the gaming system may overlay or otherwise display the winning side bet symbol indication 422 in connection with a side bet symbol selection area 420 associated with a winning selected side bet symbol. For example, FIG. 4B shows that the game screen 400 positions winning side bet symbol indications 422 over side bet symbol selection areas 420b associated with the Grape symbol based on determining that that the Grape symbol is included in a winning combination of game symbols along pay line 412, and over side bet symbol selection areas 420c associated with the Scatter symbol based on determining that that the Scatter symbol is included in a winning scatter symbol combination at symbol displays areas 410a, 410c, and 410j. In some implementations, the gaming system may overlay or otherwise display the winning side bet symbol indication 422 in connection with one or more of the symbol display areas 410a-410o displaying a winning selected side bet symbol. In the example shown in FIG. 4B, the gaming system may overlay or otherwise display the winning side bet symbol indication 422 in connection with one or more of the symbol display areas 410a-410o displaying a selected side bet symbol associated with a winning scatter symbol combination.

The player may continue the gaming session (e.g., another consecutive play of the game) by executing another play of the game. That is, the player may place another wager and start a new play of the game as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

In some implementations, the gaming system may keep one or more selected side bet symbol active (e.g., a side bet symbol button 420 may remain selected) for a next play of the game or for one or more next plays of the game. In some such implementations, the gaming system may automatically place wagers on previously selected side bet symbols for one or more next plays of the game and deduct the relevant credits for such side bet wagers. For example, the gaming system may keep the selected side bet symbol buttons 420b and 420c as selected (e.g., active) for the next play of the game. Keeping a prior side bet active enables the gaming system to offer the player to automatically make side bets on their favorite or lucky symbols for multiple plays of a game. In such implementations, the player does not have to remember to place the side bet wager in every new play of a game, which can be tiring, create additional complexity in a game (e.g., the player has to make additional selections), and may discourage players from making side bet wagers. In some implementations, a selected side bet symbol may be kept active for as long as the player has credits to wager or for a predetermined quantity of plays of a game (e.g., five next plays of a game, until the player selects a different side bet, or selects to cancel any or all active side bet wagers, etc.).

Turning now to FIG. 4C, in some implementations, the gaming system may change the available selectable side bet symbols in different plays of a game. In some implementations, the gaming system changes one or more available selectable side bet symbols every new play of the game. For example, in some implementations, the one or more available selectable side bet symbols can be randomly changed (e.g., so that different symbols can be offered for a side bet). In some implementations, the gaming system changes one or more available selectable side bet symbols after a predetermined quantity of plays of a game. In some implementations, the gaming system changes one or more available selectable side bet symbols after a randomly determined number of plays of a game.

In FIG. 4C, the gaming system has randomly determined three new side bet symbols. The gaming system in FIG. 4C modified side bet symbol button 420a to display a Jack (“J”) symbol; side bet symbol button 420b to display a 10 symbol; and side bet symbol button 420c to display a Cherry symbol. The gaming system has modified the side bet information areas 415a-415c and 417a-417c to identify different required wagers and winning amounts associated with the changed side bet symbols in side bet selection buttons 420a-420c. For example, the gaming system has modified different required wagers and winning amounts in the side bet information areas 415a-415c and 417a-417c to reflect the presence and frequency that side bet symbols appear in the reel symbols for reels 402a-402e.

In this example, the player has selected all three side bet symbol buttons 420a-420c and has started a new play of the game, such that new symbols are generated in symbol display areas 410a-410o (e.g., using an RNG). The gaming system displays the generated symbols in symbol display areas 410a-410o based on the new play of the game. In FIG. 4C, the symbols displayed on reels 402a-402e illustrate the randomly generated symbols from the symbol sets after the reels have stopped spinning. As illustrated in FIG. 4C, the gaming system randomly generated and displayed new symbols in symbol display areas 410a-410o for reels 402a-402e. For example, the gaming system generated and displayed a Jack (“J”) symbol in symbol display area 410a; Orange symbols in symbol display areas 410b and 410h; a 10 symbol in symbol display area 410c; Grape symbols in symbol display areas 410d, 410e, and 410f; Queen (“Q”) symbols in symbol display areas 410g, 410k, 410m, 410n, and 410o; King (“K”) symbols in symbol display areas 410i and 410j; and a Bell symbol in symbol display area 410l. It should be appreciated that the displayed symbol combinations are merely for explanatory purposes and the gaming system may randomly generate any suitable combination of symbols based on defined symbol sets associated with the reels 402a-402e. In the implementation illustrated in FIG. 4C, the gaming system evaluated the generated symbol combinations for winning symbol combinations and for side bets.

For example, in FIG. 4C, the gaming system executed an evaluation of the generated symbols on reels 402a-402e for winning symbol combinations and has identified a winning pay line 413. As noted above, the player may have wagered on one or more pay lines. In some implementations, at least the active (wagered on pay lines) are evaluated for winning symbol combinations, and any suitable number of pay lines may be used to evaluate winning symbol combinations. The gaming system may provide an award associated with the winning symbol combination of five Queen symbols in pay line 413 in accordance with a pay table (not shown) associated with the game. The gaming system may also update the player's gaming credit balance or do so at a later time.

The gaming system may further execute an evaluation of the generated symbols on reels 402a-402e for side bets associated with selected side bet symbols (e.g., when the player places side bet wagers). For example, the gaming system may evaluate the generated symbols for winning symbol combinations that include the selected one or more side bet symbols. In the example shown in FIG. 4C, the player selected side bet symbol selection buttons 420a-420c to place side bet wagers on the Jack, 10, and Grape symbols, but the gaming system determined that none of the selected side bet symbols are included in an active and winning pay line (e.g., pay line 413).

In some implementations, the gaming system may further evaluate the displayed symbols in the symbol display areas for the selected side bet symbols. In some implementations, the gaming system may determine that a side bet is a winning side bet when a selected side bet symbol is generated anywhere in the visible symbol display areas 410a-410o. As shown in the example of FIG. 4C, the gaming system further evaluated the generated symbols for symbol display areas that include one or more of the selected side bet symbols. In FIG. 4C, the gaming system determined that the player won the side bets for the Jack and the 10 symbols selected in side bet selection buttons 420a and 410b since these symbols were generated and displayed in symbol displays areas 410a and 410c. The gaming system may provide the side bet awards associated with the scatter winning symbol combinations of Jack and the 10 symbols based on the pay amount identified in side bet information area 417a and 417b associated with the Jack and 10 symbols. In some implementations, the pay amount may be lower (e.g., 110 for the Jack symbol and 70 for the 10 symbol, or some other suitable values) than the displayed amount because Jack and 10 symbols were not generated in winning symbol combinations of Jack and 10 symbols, respectively. The gaming system may also update the player's gaming credit balance or do so at a later time to reflect the awards associated with winning the side bets associated with the Jack and 10 symbols.

In the example shown in FIG. 4C, the gaming system also updates the side bet selection buttons 420a and 420b to include the winning side bet symbol indication 422 since the selected Jack and 10 side bet symbols are associated with winning side bets. In the example shown in FIG. 4C, the gaming system also overlays or otherwise displays the winning side bet symbol indication 422 in connection with one or more of the symbol display areas 410a and 410c displaying the selected Jack and 10 symbols associated with winning side bets.

In some implementations, the gaming system may enable a player to select one or more symbol display areas 410a-410o and place a side bet wager that the gaming system will generate a particular symbol in the selected one or more symbol display areas during the next play of the game. In the example shown in FIG. 4C, the player has placed a side bet on the Jack, 10, and Cherry symbols in side bet symbol selection buttons 420a-420c. In some implementations, the gaming system may accept an input from the player identifying one or more symbol display areas 410a-410o to place a side bet wager that the gaming system will generate one of the selected the Jack, 10, or Cherry symbols in the selected one or more symbol display areas during the next play of the game. The gaming system may then evaluate the generated symbols to determine whether the player won the side bets for the Jack, 10, or Cherry symbols based on whether any these symbols were generated and displayed in selected symbol displays areas 410a-410o.

In some implementations, the gaming system enables the player to place side bet wagers on one or more particular pay lines. In some implementations, the gaming system may enable the player to select any available pay line for a side wager. For example, before the generation and display of symbols in symbol display areas 410a-410o, the gaming system may present one or more possible pay lines and receive an input selecting one or more of the possible pay lines for a side bet. For example, the gaming system may evaluate the generated symbols for winning combinations and may provide an award for any winning combinations based on a pay table. The gaming system may further provide an additional award if the winning combination occurs on a selected pay line associated with a side bet. In other implementations, the gaming system provides a predetermined quantity of pay lines (e.g., fewer than the total amount of available pay lines) that are available for a side bet. For example, in some implementations, the gaming system may enable a player to place a side bet wager on pay line 413 of FIG. 4C for one or more plays of the game. In such an example, if the gaming system generated a winning symbol combination on pay line 413, the player may win the side bet award associated with the winning symbol combination on pay line 413 (e.g., the standard game award associated with a pay table) as well as winning the side bet wager on pay line 413.

FIGS. 5A and 5B show screen shots of one or more gaming system displays illustrating example side bet implementations in accordance with aspects of the present disclosure. More specifically, FIGS. 5A and 5B illustrate screen shots of one implementation of a gaming system having a slide out information area that is displayed with a game to enable a player to select side bet symbols or other game information related to side bet.

FIGS. 5A and 5B illustrate certain implementation of a game screen 500 that the gaming system 100 may display on a display device of the gaming system. For the sake of brevity, FIGS. 5A and 5B share features (e.g., symbol display areas 510a-510o associated with reels 502a-502e) similar to the features already discussed above in connection with FIGS. 3A, 3B, and 4A-4C and such similar feature will not be described again. In some implementations, game screen 500 may be displayed on a first display 120 of gaming system 100 illustrated in FIG. 1. However, any other suitable display may be used.

Game screen 500 also includes several information areas and buttons 505a-505i. These information areas and buttons 505a-505i are illustrated in a particular arrangement but may be arranged in any suitable manner in different implementations. In some implementations, game screen 500 may include more or fewer display areas and buttons 505a-505i than illustrated in FIGS. 5A and B. Information area 505a illustrates an example value of one credit for the game displayed in game screen 500. Information areas 505b and 505c illustrate an example of the amount of the player's available credits. Information area 505d illustrates the amount of credits a player has won. Because FIG. 5A illustrates the start of a play of a game, the information area 505d shows zero credits have been won. Button 505e illustrates a software button that the player can select to place a bet or wager. It should be appreciated that the functionality of button 505e may also be replicated or replaced with a hardware button on the gaming device 100. Information area 505f illustrates that the player has selected to wager 20 credits. Button 505g illustrates a software button that the player can select to determine how many pay lines to wager on. It should be appreciated that the functionality of button 505g may also be replicated or replaced with a hardware button on the gaming device 100. Information area 505h illustrates that the player selected to wager on 10 pay lines. Button 505i illustrates a software button that the player can select to obtain information about the game, change certain aspects of the game, obtain help, place an order, etc.

In one implementation, if a player selects button 505i, the gaming system executes code to open or otherwise activate a slide out information area 530. As illustrated in FIG. 5A, the gaming system may also enable a player to use a touch screen and digitizer to “swipe” open the slide out information area 530. For example, the gaming system may await the activation of a left to right movement (e.g., “a swipe”) on or around virtual button 525 on a touch screen as shown with direction arrow 527. The gaming system may process this swipe as a request or similar to a request to activate the slide out information area 530. As noted above, when activating the slide out information area 530, the gaming system may be configured to provide any suitable information in the slide out information area related to side bets.

Turning now to FIG. 5B, the gaming system in some implementations may provide a slide out information area 530 that presents a predetermined quantity of selectable side bet symbols in the selectable side bet symbol set in a pop out or slide out window (e.g., a slide out information area) 530 of a game screen 500. In some implementations, if all of the selectable side bet symbols of the selectable side bet symbol set are not visible, the gaming system may enable the player to scroll through available selectable side bet symbols within the slide out information area 530. In some implementations, a slide out information area 530 also provides the player with symbol pay table information and/or other suitable game information, such as side bet wager information, side bet award information, jackpot information, player tracking information, awards, offers, etc. In some implementations, the gaming system may close the slide out information area 530 when the gaming system detects a swipe in the opposite direction (e.g., opposite to direction arrow 527).

While FIGS. 5A and 5B illustrate a slide out information area on the left side of the game screen 500, the gaming system can be configured to provide the slide out information area on any side of the screen (including on one or more sides of the screen at a time). In some implementations, the game display, or how a game is displayed, may constrain the slide out information area to a particular side of the screen. It should also be appreciated that the slide out information area may be provided on different display screens in some implementations.

Continuing with FIG. 5B, the gaming system opened the slide out information area to reveal that the gaming system retrieved symbol pay information for display in the slide out information area 530. In one implementation, the gaming system provides a predetermined quantity of symbols in the slide out information area 530. In the illustrated implementation, the gaming system displayed six selectable side bet symbols 532a, 532b, 532c, 532d, 532e, and 532f in slide out information area 530. The gaming system enables the player to select one or more of the side bet symbols at a time to obtain information about this side bet symbol as it relates to a game (e.g., the slot reel game shown in FIGS. 4A-4C, 5A, and 5B, or some other suitable game). In the illustrated implementation, the side bet symbols shown in slide out information area 530 may correspond to or be included in one or more sets of symbols that can be generated and displayed on reels 502a-502e. In some implementations, more side bet symbols could be shown in slide out information area 530 to correspond to the different symbols generated for a play of a game. For example, the size of the symbols shown in slide out information area 530 could be reduced to fit more symbols. However, in some implementations, the number of displayed symbols in slide out information area 530 is predetermined. In some such implementations, the gaming system enables the player to access more of the game symbols or all of the game symbols, such as by scrolling through the available symbols. In some implementations, slide out information area 530 may be increased in size to accommodate more displayed symbols (e.g., having more than one row of symbols displayed in slide out information area 530). In other implementations, one or more additional slide out information areas 530 may be included on other sides of the game screen 400 to show more information, such as to identify additional selectable side bet symbols.

In one example illustrated in FIG. 5B, the gaming system enables a player to select Cherry symbol 532a for more information. The selection of Cherry symbol 532a is further indicated to the player using any suitable mechanism. As illustrated in FIG. 5B, the gaming system may provide highlighting over selected Cherry side bet symbol 532a, but other indicators could be used alone or in conjunction with the depicted highlighting, such as audio output, highlighted borders with various colors, etc.).

In some implementations, if additional information is available for the selected Cherry symbol 532a, the gaming system displays the available information. As shown in FIG. 5B, the gaming system generates an additional information area 538 showing pay table information for the Cherry symbol 532a. In the example shown in FIG. 5B, the pay table information reveals that when the gaming system generates three Cherry symbols on an active pay line, the gaming system will award the player with an additional 300 credits. When the gaming system generates four Cherry symbols on an active pay line, the gaming system will award the player with an additional 1350 credits. When the gaming system generates five Cherry symbols on an active pay line, the gaming system will award the player with 9000 credits.

As further shown in FIG. 5B, the gaming system generates an additional side bet information area 540 showing side bet information for the Cherry symbol 532a. In the example shown in FIG. 5B, the side bet information in additional side bet information area 540 reveals that a side bet wager for the Cherry symbol costs 50 credits and will award the player with 100 credits if the Cherry symbol is included in a winning symbol combination (e.g., on an active pay line).

It should be appreciated that the credits shown are merely for illustration purposes and any suitable credits can be assigned to the displayed winning symbol side bet combinations. In some implementations, the gaming system may display more information about the selected symbol, such as varying winning credit amounts based on the player's wager. However, in some implementations, in an effort to save memory and to obtain faster data retrieval times, the gaming system may store only the minimum amount of information on a symbol. For example, if different wager amounts changed the Cherry symbol's pay table, the gaming system may dynamically calculate and update the Cherry's symbol's pay table as displayed in additional information area 538 and 540. In one such implementation, if the player increases the player's bet per active pay line, the Cherry symbol's award amounts may increase. Likewise, in another such implementation, if the player increases the player's wager amount for a side bet, the Cherry symbol's side bet award amounts may increase. Rather than store all of the different variations of the different award amounts (and require multiple accesses to the data store), the gaming system may dynamically update the displayed pay table as the player alters the bet amount per active pay line. Thus, it should be appreciated that the dynamic updating system more efficiently utilizes the gaming system's hardware resources.

Furthermore, the player may activate a side bet with the Cherry symbol by making a selection in the additional side bet information area 540. For example, FIG. 5B shows a cursor clicking on (e.g., a player touches side bet information area 540) the additional side bet information area 540 associated with the Cherry side bet symbol 532a to place a side bet wager for the Cherry symbol by wagering the indicated quantity of credits.

It should be appreciated that the slide out information area enables the gaming system to provide many more side bet wagers on more symbols, without having to alter or obscure the game (e.g., the game screen area used for the reels 502a-502e, or other suitable games).

In some implementations, the gaming system may enable a player to select different custom winning symbol combinations for a side bet wager, such as enable the play to select from the six selectable side bet symbols 532a, 532b, 532c, 532d, 532e, and 532f in slide out information area 530. In some implementations, the gaming system may dynamically determine at the time of player selection of the plurality of symbols that form a winning symbol combination, what the side bet award can be based on the statistical likelihood of the gaming system generating the symbols and the return to player value required at the gaming system. For example, the gaming system may update the additional side bet information area 540 for wager amounts and award payouts associated with different, custom combinations of side bet symbols that form a winning symbol combination.

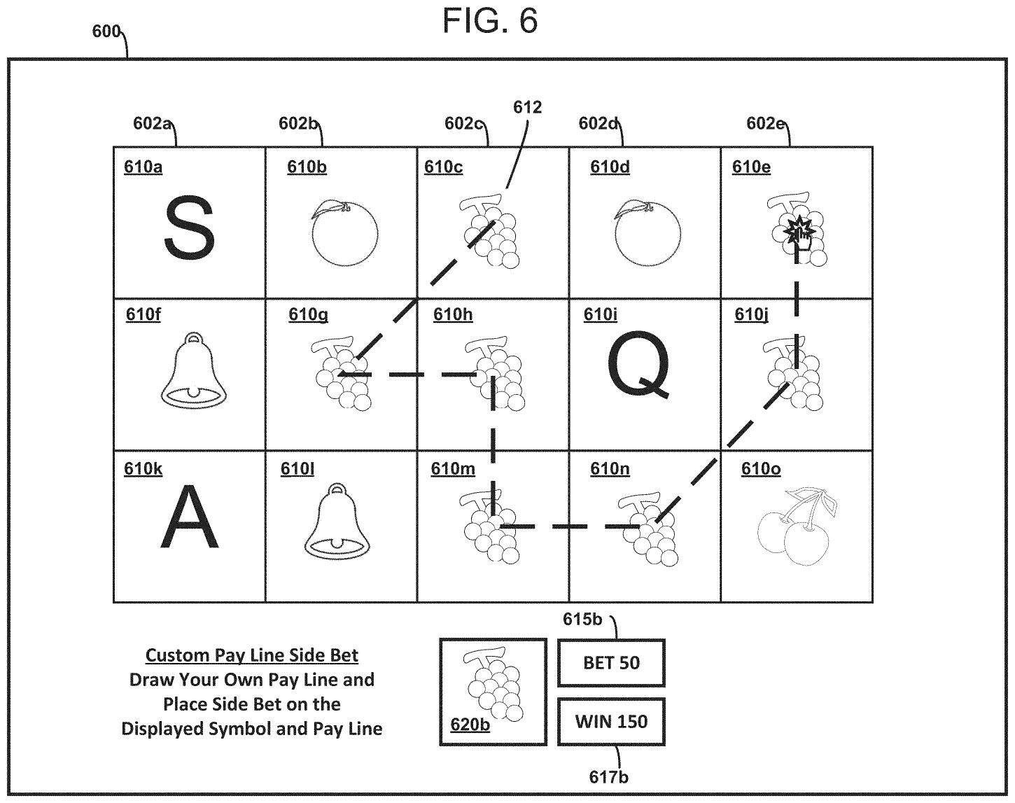

FIG. 6 shows a screen shot of one or more gaming system displays illustrating example side bet implementations in accordance with aspects of the present disclosure. More specifically, FIG. 6 illustrates a screen shot of one implementation of a gaming system for placing a side bet on a non-traditional pay line.

FIG. 6 illustrates a certain implementation of a game screen 600 that the gaming system 100 may display on a display device of the gaming system. For the sake of brevity, FIG. 6 shares certain features (e.g., symbol display areas 610a-610o associated with reels 602a-602e, side bet information regions 615b and 617b, and side bet symbol selection button 620b) similar to the features already discussed above in connection with FIGS. 3A, 3B, 4A-4C, 5A, and 5B, and such similar features will not be described again. In some implementations, game screen 600 may be displayed on a first display 120 of gaming system 100 illustrated in FIG. 1. However, any other suitable display may be used.

As shown in FIG. 6, in some implementations, the gaming system may enable the player to place a side bet on a non-traditional pay line 612. For example, if a slot reel game includes pay lines that evaluate and pay from the left reel 602a to the right reel 602e, the gaming system may offer the player side bets on one or more pay lines that pay from right to left or that are evaluated from the center reels (e.g., reels 602b, 602c, and 602d). In some implementations, the non-traditional pay lines 612 that are available for a side bet wager are predetermined and the player can select from an available list of non-traditional pay lines.

In an implementation shown in FIG. 6, the gaming system enables the player to pick the player's own non-traditional pay line. For example, in some implementations, the gaming system enables a player to draw a pay line 612 based on one or more received user inputs. In some implementations, the gaming system may enable the player to pick the start and the end of a pay line 612 anywhere in a game screen. For example, the game screen 600 may be provided on touch screen that receives a touch input from the player defining the pay line 612. For example, the player may contact one or more symbol display areas 610a-610o to include in a defined pay line 612. In the example shown in FIG. 6, the user has traced a path through symbol display areas 610c, 610g, 610h, 610m, 610n, 610j, and 610e. Thus, the pay line may start evaluating winning symbol combinations in the center of reels or symbol display areas and/or in various non-traditional directions (up, down left to right, diagonally, etc.) in some implementations. In some implementations, custom player drawn pay lines may have minimum number of symbol display areas and reels that must be included in the player's unique pay line (e.g., at least three symbol display areas). In some implementations, custom player drawn pay lines may have maximum number of symbol display areas and reels that can be included in the player's unique pay line (e.g., seven symbol display areas or some other suitable number). In some implementations, the gaming system may require that a custom player drawn pay line be drawn through adjacent symbol display areas, where each symbol display area in a pay line can only be used once for one pay line evaluation. In some implementations, the gaming system may enable a custom player drawn pay line to be drawn through one or more symbol display areas more than once, wherein an evaluation of the player's custom pay line can follow the sequence the player uses to add symbol display areas to the custom pay line. In such an implementation where the custom player drawn pay line includes a particular symbol display areas more than once along the pay line, the gaming system may evaluate the particular symbol display area more than once for the same pay line.

In some implementations, if a winning symbol combination is generated on the player's unique pay line, the player wins the side bet. The winning symbol combination may be based on an existing pay table or could be based on the player custom selected symbols that form a winning symbol combination. The gaming system may vary side bet awards based on the quantities of symbols in a pay line or the design of the pay line.

Based on the forgoing description, it should be appreciated that a gaming system and method for placing and evaluating different side bets for awards creates new and very exciting ways for a player to obtain improved winnings with a potential to earn frequent and greater awards. Such a potential to earn greater awards creates a greatly improved sense of anticipation for players.

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a cabinet;
a processor;
a display device supported by the cabinet;
an input device supported by the cabinet;
a value acceptor supported by the cabinet;
a value dispenser supported by the cabinet;
a memory device that stores a plurality of instructions which, when executed by the processor, cause the processor to:
establish a credit balance based on a monetary value received by the value acceptor;
receive a wager amount via the input device, wherein the credit balance is decreased by the wager amount;
receive a selection of one of a plurality of side bet symbols;
automatically deduct a side bet wager amount based on the selected side bet symbol, wherein the credit balance is decreased by the side bet wager amount;
randomly generate a plurality of symbols in a plurality of symbol display areas;
display the plurality of symbols in the plurality of symbol display areas;
determine an award based on any winning symbol combinations in the generated plurality of symbols in the plurality of symbol display areas;
determine a side bet award when the selected side bet symbol is contained in the any winning symbol combinations of the generated plurality of symbols;
display, on the display device, the determined award and the side bet award;
increase the credit balance by the award and the side bet award; and
issue a monetary value from the value dispenser based on the credit balance upon receipt of a cash out signal via the input device.

2. The gaming system of claim 1, wherein the plurality of symbols are generated from one or more symbol sets, and wherein the plurality of side bet symbols are formed from a side bet symbol set.

3. The gaming system of claim 2, wherein side bet symbols in the side bet symbol set comprise symbols in the one or more symbol sets.

4. The gaming system of claim 1, wherein the plurality of side bet symbols comprises a predetermined quantity of side bet symbols.

5. The gaming system of claim 1, wherein the processor further receives a plurality of selections of the plurality of side bet symbols.

6. The gaming system of claim 1, wherein the processor automatically deducts at least one additional side bet wager amount based on the selected side bet symbol for a next play of a game without receiving another selection on the selected side bet symbol.

7. The gaming system of claim 1, wherein the processor displays the plurality of side bet symbols, and the processor further changes at least one of the displayed plurality of side bet symbols for a next play of a game.

8. The gaming system of claim 1, wherein the processor further:
receives a second side bet wager on one of a plurality of pay lines; and
automatically deducts a second side bet wager amount based on the second side bet wager, wherein the credit balance is decreased by the second side bet wager amount.

9. The gaming system of claim 8, wherein the processor further:
determines a second side bet award based on a winning symbol combination appearing along the one of the plurality of pay lines with the second side bet wager.

10. The gaming system of claim 1, wherein the processor further:
further comprising receiving a second side bet wager on one of a plurality of non-traditional pay lines;
automatically deducting a second side bet wager amount based on the second side bet wager, wherein the credit balance is decreased by the second side bet wager amount.

11. The gaming system of claim 10, wherein the plurality of non-traditional pay lines comprises pay lines that do not start from a left most side of the plurality of symbol display areas.

12. The gaming system of claim 10, further comprising receiving a second side bet wager on at least one player drawn pay line;
automatically deducting a second side bet wager amount based on the second side bet wager, wherein the credit balance is decreased by the second side bet wager amount.

13. The gaming system of claim 12, further comprising a touch screen input device that receives the at least one player drawn pay line.

14. The gaming system of claim 1, wherein the plurality of side bet symbols are displayed in a slide out information area.

15. A method of operating a gaming system, the method comprising:
receiving, by a monetary value acceptor, a monetary value;
establishing, by a processor of the gaming system, a credit balance based at least in part on the received monetary value;
accepting, from an input device in a housing of the gaming system, a wager amount wherein the credit balance is decreased by the wager amount;
receiving a selection of one of a plurality of side bet symbols;
automatically deducting a side bet wager amount based on the selected side bet symbol, wherein the credit balance is decreased by the side bet wager amount;
randomly generating a plurality of symbols in a plurality of symbol display areas;
displaying, on a display device, the plurality of symbols in the plurality of symbol display areas;
determining an award based on any winning symbol combinations in the generated plurality of symbols in the plurality of symbol display areas;
determining a side bet award when the selected side bet symbol is contained in the any winning symbol combinations of the generated plurality of symbols;
displaying, on the display device, the determined award and the side bet award;
increasing the credit balance by the award and the side bet award; and
issuing a monetary value from a value dispenser based on the credit balance upon receipt of a cash out signal via the input device.

16. The method of claim 15, wherein the plurality of symbols are generated from one or more symbol sets, wherein the plurality of side bet symbols are formed from a side bet symbol set, and wherein side bet symbols in the side bet symbol set comprise symbols in the one or more symbol sets.

17. The method of claim 15, further comprising:
automatically deducting at least one additional side bet wager amount based on the selected side bet symbol for a next play of a game without receiving another selection on the selected side bet symbol.

18. The method of claim 15, further comprising:
receiving a second side bet wager on one of a plurality of pay lines;
automatically deducting a second side bet wager amount based on the second side bet wager, wherein the credit balance is decreased by the second side bet wager amount; and
determining a second side bet award based on a winning symbol combination appearing along the one of the plurality of pay lines with the second side bet wager.

19. The method of operating the gaming system of claim 15, further comprising:
receiving a second side bet wager on at least one player drawn pay line;
automatically deducting a second side bet wager amount based on the second side bet wager, wherein the credit balance is decreased by the second side bet wager amount; and
determining a second side bet award based on a winning symbol combination appearing along the at least one player drawn pay line.

20. A non-transitory computer-readable storage medium having machine instructions stored therein, the instructions being executable by a processor to cause the processor to:
establish a credit balance based at least in part on a monetary value received by a value acceptor of a gaming device;
receive a wager amount via an input device, wherein the credit balance is decreased by the wager amount;
receive a selection of one of a plurality of side bet symbols;
automatically deduct a side bet wager amount based on the selected side bet symbol, wherein the credit balance is decreased by the side bet wager amount;
randomly generate a plurality of symbols in a plurality of symbol display areas;
display, on a display device, the plurality of symbols in the plurality of symbol display areas;
determine an award based on any winning symbol combinations in the generated plurality of symbols in the plurality of symbol display areas;
determine a side bet award when the selected side bet symbol is contained in the any winning symbol combinations of the generated plurality of symbols;
display, on the display device, the determined award and the side bet award;
increase the credit balance by the award and the side bet award; and
issue a monetary value from a value dispenser based on the credit balance upon receipt of a cash out signal via the input device.
